(19) United States
(12) Patent Application Publication
(10) Pub. No.: US 2015/0141532 A1
(43) Pub. Date: May 21, 2015

(54) Solvent-Substitution Solvent Used in Aerogel Production, and Hydrophobised Aerogel Production Method Using Same

(71) Applicant: REMTECH CO., LTD., Daejeon (KR)

(72) Inventors: Byoung-Hoon Kim, Seoul (KR); Jeong-Kun Yoo, Seoul (KR); Jung-Ho Han, Seoul (KR); Roshan Wagle, Daejeon (KR)

(21) Appl. No.: 14/398,843

(22) PCT Filed: May 9, 2013
(86) PCT No.: PCT/KR2013/004068

§ 371 Date: Nov. 4, 2014

(30) Foreign Application Priority Data
May 11, 2012 (KR) 10-2012-0050127

(51) Int. Cl. C01B 33/155; C01B 33/158

(52) U.S. Cl. CPC C01B 33/155; C01B 33/1585
USPC 516/104; 516/98; 252/364; 516/111; 516/99

(57) ABSTRACT

Provided are a solvent-substitution solvent for producing a hydrophobized aerogel and a method for producing a hydrophobized aerogel. The solvent-substitution solvent includes pentanol in an amount of 41 wt % to 100 wt % and n-butanol in an amount of 0 wt % to 59 wt %. The method includes performing a solvent substitution process using the solvent-substitution solvent. If the solvent-substitution solvent is used for solvent substitution and/or hydrophobization in an aerogel production process, water (moisture) contained in a wet gel may be effectively substituted with the solvent-substitution solvent, and the solvent-substitution solvent may easily be collected at a high degree of purity and may be reused if necessary. Therefore, the rate of solvent loss may be minimized. In addition, if the solvent-substitution solvent is used for solvent substitution, a hydrophobized aerogel may be obtained without having to perform a hydrophobizing process using an additional hydrophobizing agent such as a silylating agent.

### TECHNICAL FIELD

The present disclosure relates to a solvent-substitution solvent for producing a hydrophobized aerogel and a method for producing a hydrophobized aerogel using the solvent-substitution solvent. More particularly, the present disclosure relates to a solvent-substitution solvent for producing a hydrophobized aerogel while allowing a solvent to be easily collected and reused to minimize solvent loss, allowing the content of a silylating agent to be easily controlled, allowing moisture of a wet gel to be effectively replaced, and allowing the porosity of a lyogel to be maintained at a high-quality level during drying, as well as a method for producing a hydrophobized aerogel using the solvent-substitution solvent.

### BACKGROUND ART

Along with recent developments in the field of advanced industrial technology, there is increasing interest in aerogels. Aerogel is an advanced ultra-low-density material having a porosity of 90% or higher, a specific surface area of several hundreds of m²/g up to about 1500 m²/g according to the kind of starting raw material, and a nanoporous structure. Nanoporous aerogels may be used in applications such as ultra low dielectric materials, catalysts, electrode materials, and sound proofing materials. Particularly, silica aerogel having a low degree of thermal conductivity is a very effective super-insulation material usable in refrigerators, automobiles, airplanes, and other applications.

Such aerogels may be manufactured using various methods. For example, WO95/06617 discloses a method of producing a hydrophobic silica aerogel by reacting water glass with sulfuric acid or the like at a pH of 7.5 to 11 to form a silica hydrogel, washing the silica hydrogel with water or a diluted aqueous solution of an inorganic salt (sodium hydroxide or ammonia) at a pH of 7.5 to 11 so as to remove ion components from the silica hydrogel, removing water with a C₁₋₅ alcohol, and drying the silica hydrogel at 240° C. to 280° C. under supercritical conditions of 55 bars to 90 bars of pressure. In the disclosed method, the supercritical drying process is carried out without performing a silylating process.

WO96/22942 discloses a method of producing an aerogel by performing an optional solvent-substitution process on silicate wet gel for substitution with an organic solvent (methanol, ethanol, propanol, acetone, tetrahydrofuran, or the like), and reacting the silicate wet gel with at least one silylating agent not including chlorine, and drying the silicate wet gel under supercritical conditions.

WO98/23367 discloses a method of producing an aerogel by reacting water glass with an acid to form a wet gel, washing the wet gel with an organic solvent (i.e., an alcohol such as methanol or ethanol, acetone, ketone, or the like) so that the wet gel has a water content of 5 wt % or less; and performing silylating and drying processes on the wet gel.

WO97/17288 discloses a method of producing an aerogel by preparing silicic sol having a pH of 4.0 or less from an aqueous water glass solution and organic and/or inorganic acids, separating salts formed by the acids and water glass cations from the silicic sol at 0° C. to 30° C., adding a base to the silicic sol to form SiO₂ gel by polycondensation, washing the SiO₂ gel with an organic solvent (such as an aliphatic alcohol, ether, ester, ketone, or an aliphatic or aromatic hydrocarbon) until the SiO₂ gel has a water content of 5 wt % or less, and performing silylating and drying processes on the SiO₂ gel.

WO98/23366 discloses a method of producing an aerogel by forming a hydrogel at a pH of 3 or greater; mixing the hydrogel with a hydrophobic agent to modify the surface of the hydrogel; optionally washing the modified hydrogel with a protic or aprotic solvent (methanol, ethanol, ether, ester, ketone, or aliphatic or aromatic hydrocarbon, or the like) or a silylating agent, and drying the washed hydrogel. The disclosed method does not require a solvent exchange process.

Korean Patent Application No. 2004-72145 discloses a technique for removing moisture from silica by using n-butanol, propanol, and a mixture thereof so as to produce silica having nano-sized particles.

Korean Patent Application No. 2006-878841 discloses a method including: adding water glass (sodium silicate) to HCl to form silica gel at an acidity of pH 3 to pH 5; washing the silica gel with distilled water and filtering the silica gel; refluxing the silica gel for 4 hours to 12 hours in a mixture of 1% to 30% by weight of a silylating agent such as hexamethyldisilane, ethyltriethoxysilane, triethylethoxysilane, ethyltrimethoxysilane, or methoxytrimethylsilane and 70% to 99% by weight of alcohols (methanol, ethanol, propanol, etc) so as to modify the surface of the silica gel; filtering the silylated silica gel; and performing a solvent exchange process on the silylated silica gel by using n-butanol to remove moisture and reaction residues from the silica gel simultaneously. However, according to the disclosed method, it is impossible to collect and reuse an alcohol solution and a silylating agent. That is, since a large amount of an expensive silylating agent is used, the manufacturing cost of products may be very high, and thus the disclosed method is relatively uneconomical.

Korean Patent Application No. 2007-25662 discloses a processing method simpler than the above-mentioned method, the processing method including: adding water glass (sodium silicate) to HCl to form silica gel under an acidic condition of pH 3 to pH 5; washing the silica gel with distilled water and filtering the silica gel; treating the silica gel with a mixture solution of n-butanol and a silylating agent such as hexamethyldisilane, ethyltriethoxysilane, triethylethoxysilane, ethyltrimethoxysilane, or methoxytrimethylsilane, so as to silylate the silica gel and remove moisture and reaction residues from the silica gel simultaneously. However, the disclosed processing method inevitably leads to the loss of butanol, and even a collected butanol solvent has low quality because a relatively large amount of water may be dissolved therein.

### DISCLOSURE

### Technical Problem

An aspect of the present disclosure may provide a solvent-substitution solvent for producing an aerogel having hydrophobicity by surface modification.

An aspect of the present disclosure may also provide a solvent-substitution solvent for producing an aerogel having a high degree of porosity and hydrophobicity by surface modification.

An aspect of the present disclosure may also provide a solvent-substitution solvent for producing an aerogel having hydrophobicity by surface modification while allowing a large amount of used solvent to be collected, reusing the solvent if necessary, and minimizing a rate of solvent loss.

An aspect of the present disclosure may also provide a solvent-substitution solvent for producing an aerogel having hydrophobicity by surface modification while easily controlling the content of a silylating agent.

An aspect of the present disclosure may also provide a method for producing an aerogel having hydrophobicity by surface modification using the solvent-substitution solvent.

### Technical Solution

According to an aspect of the present disclosure, a solvent-substitution solvent for producing an aerogel may include pentanol in an amount of 41 wt % to 100 wt % and n-butanol in an amount of 0 wt % to 59 wt %.

According to another aspect of the present disclosure, the solvent-substitution solvent may include the pentanol in an amount of 41 wt % to less than 100 wt % and the n-butanol in an amount of greater than 0 wt % to 59 wt %.

According to another aspect of the present disclosure, the solvent-substitution solvent may include the pentanol in an amount of 55 wt % to 95 wt % and the n-butanol in an amount of 5 wt % to 45 wt %.

According to another aspect of the present disclosure, the solvent-substitution solvent may further include at least one alcohol selected from the group consisting of methanol, ethanol, and propanol.

According to another aspect of the present disclosure, the pentanol may include at least one selected from the group consisting of n-pentanol, sec-amyl alcohol (CH₃CH₂CH₂CH(OH)CH₃), 3-pentanol (CH₃CH₂CH(OH)CH₂CH₃), isoamyl alcohol (CH₃(CH₃)CHCH₂CH₂OH), active amyl alcohol (CH₃CH₂CH(CH₃)CH₂OH), sec-isoamyl alcohol ((CH₃)₂CHCH(OH)CH₃), t-butyl carbinol (CH₃(CH₃)₂CCH₂OH), and t-amyl alcohol (CH₃CH₂C(CH₃)₂OH).

According to another aspect of the present disclosure, a method for producing a hydrophobized aerogel may include substituting a solvent of a wet gel with the solvent-substitution solvent.

According to another aspect of the present disclosure, the wet gel may be prepared by adding water glass to hydrochloric acid or sulfuric acid until a pH of 3 to 6 is obtained.

According to another aspect of the present disclosure, in the substituting of the solvent of the wet gel, the solvent-substitution solvent may be used together with a silylating agent.

According to another aspect of the present disclosure, after the substituting of the solvent of the wet gel, the method may further include hydrophobizing a lyogel by using a silylating agent, the lyogel being obtained through the substituting of the solvent of the wet gel.

According to another aspect of the present disclosure, the substituting of the solvent of the wet gel may be performed through a reflux distillation process or a forced contact process.

According to another aspect of the present disclosure, the silylating agent may be selected from the group consisting of a substance represented by the following chemical formula R¹₄₋ₙ—SiXₙ and a substance represented by the following chemical formula R²Si—O—SiR³,

where n is an integer from 1 to 3,

R¹ is selected from the group consisting of a C1-C10 alkyl group, a C3-C8 aromatic group, a C3-C8 aromatic alkyl group, a C3-C7 heteroaromatic alkyl group including at least one heteroatom selected from the group consisting of O, N, S, and P, and hydrogen,

X is selected from the group consisting of a halogen selected from the group consisting of F, Cl, Br, and I, a C1-C10 alkoxy group, a C3-C8 aromatic alkoxy group, and a C3-C7 heteroaromatic alkoxy group including at least one heteroatom selected from the group consisting of O, N, S, and P, and

R² and R³ are independently selected from the group consisting of a halogen selected from the group consisting of F, Cl, Br, and I, a C1-C10 alkyl group, a C3-C8 aromatic group, a C3-C8 aromatic alkyl group, a C3-C7 heteroaromatic alkyl group including at least one heteroatom selected from the group consisting of O, N, S, and P, and hydrogen.

According to another aspect of the present disclosure, the silylating agent may be used in an amount of 1 part by weight to 500 parts by weight based on 100 parts by weight of the aerogel which is dried.

### Advantageous Effects

According to embodiments of the present disclosure, if the solvent-substitution solvent is used for solvent substitution and/or hydrophobization in an aerogel production process, water (moisture) contained in a wet gel may be effectively substituted with the solvent-substitution solvent, and the solvent-substitution solvent may easily be collected at a high degree of purity and may be reused if necessary. Therefore, the rate of solvent loss may be minimized. In addition, if the solvent-substitution solvent is used for solvent substitution, a hydrophobized aerogel may be obtained without having to perform a hydrophobizing process using an additional hydrophobizing agent such as a silylating agent. In addition, shrinkage of pores of a wet gel caused by the capillary action of a solvent may be prevented in an aerogel production process, and thus an aerogel having a high degree of porosity, hydrophobicity, specifically, permanent hydrophobicity, and a large specific surface area of 580 m²/g or greater, preferably 590 m²/g or greater, more preferably 600 m²/g, is able to be produced. Furthermore, in the method of the embodiment of the present disclosure, it may be unnecessary to adjust the content of a silylating agent to a particular value.

### DESCRIPTION OF DRAWINGS

FIG. 1 is a schematic view for explaining the concept of a method for producing an aerogel according to an embodiment of the present disclosure.

FIG. 2 is an image of an aerogel obtained through a solvent substitution process using ethanol and a drying process.

FIG. 3 is an image of a mixture solution prepared by mixing 200 ml of butanol and 100 ml of water, and adding 20 ml of methanol thereto after observing a layered state.

FIG. 4 is an image of a mixture solution prepared by mixing 200 ml of pentanol and 100 ml of water, and adding 20 ml of methanol thereto after observing a layered state.

FIG. 5 is an image of an aerogel inserted into water after the aerogel was obtained through a solvent substitution process using butanol and a drying process.

FIG. 6 is an image of an aerogel inserted into water after the aerogel was obtained through a solvent substitution process using pentanol and a drying process.

FIG. 7 is an image of an aerogel obtained through a solvent substituting and hydrophobizing process using heptanol and a drying process.

FIG. 8 is a graph illustrating solvent loss rates respectively measured after equal amounts of water and a solvent were mixed at room temperature for about 1 hour.

FIG. 9 is an image of an aerogel prepared in Example 4.

### BEST MODE

Embodiments of the present disclosure provide a solvent-substitution solvent for producing a hydrophobized aerogel having a high degree of porosity, and a method for producing a hydrophobized aerogel using the solvent-substitution solvent. As described above, aerogel is a ultra-low-density material having a large specific surface area and a high degree of porosity. Therefore, when an aerogel is produced, it may be important to effectively remove water contained in a porous structure of the aerogel without causing shrinkage of the porous structure and dry the aerogel for maintaining the porosity of the aerogel. Therefore, a solvent substitution process is generally performed using a solvent-substitution solvent suitable for preventing shrinkage of an aerogel, so as to substitute water contained in a porous structure of a wet gel with the solvent-substitution solvent.

In addition, since silica surfaces of aerogels are hydrophilic, the properties of the aerogels deteriorate with time due to the absorption of moisture contained in air. Therefore, a hydrophobizing process is generally performed to hydrophobize the silica surfaces of the aerogels.

Therefore, a solvent-substitution solvent preventing shrinkage of pores, allowing for easy control of the amount of a hydrophobizing agent (such as a silylating agent), and collectable and reusable after being used in a solvent substituting and/or hydrophobizing process is needed when aerogel is produced. In addition, a method for producing an aerogel using such a solvent-substitution solvent is needed.

If the solvent-substitution solvent of the embodiment of the present disclosure is used to produce an aerogel, moisture of a wet gel may be effectively removed through a solvent substitution process. In addition, the shrinkage of pores caused by capillarity may be prevented to maintain a high degree of porosity, and eventually an aerogel having a large specific surface area, a high degree of porosity, and hydrophobicity, for example, permanent hydrophobicity may be produced. Furthermore, in a solvent substitution process using the solvent-substitution solvent of the embodiment of the present disclosure, the surface of an aerogel may be hydrophobized. Therefore, a hydrophobized aerogel may be obtained without having to perform a hydrophobizing process using an additional hydrophobizing agent such as a silylating agent.

In addition, since the solvent-substitution solvent of the embodiment of the present disclosure is easily separated from water removed from a wet gel, the solvent-substitution solvent may be easily collected at a high rate. Furthermore, the solvent-substitution solvent may be collected with a high degree of purity. Therefore, the loss rate of a solvent may be markedly decreased. Specifically, when an aerogel is produced using a distillation process, the loss rate of a solvent may be markedly decreased. Furthermore, the solvent-substitution solvent of the embodiment of the present disclosure may be used together with a silylating agent to perform solvent substitution and hydrophobization simultaneously. In this case, although the amount of the silylating agent is not controlled within a particular range, the solvent-substitution solvent may be easily separated from reaction residues and collected. That is, since it is not necessary to adjust the amount of a silylating agent within a particular range, processes for producing an aerogel may be easily controlled.

Hereinafter, technical features resulting from the use of the solvent-substitution solvent of the embodiment of the present disclosure will be described in detail. As described above, in an aerogel production process, it is important to effectively and quickly substitute water of a wet gel with a solvent for removing water from the wet gel and dry the wet gel without causing shrinkage of pores for producing an aerogel having a high degree of porosity, a large specific surface area, and insulating characteristics. To effectively substitute water (moisture) contained in a large number of fine pores of a wet gel without causing shrinkage of the pores, it may be necessary for a solvent-substitution solvent to pass through fine pores without causing shrinkage of the pores by capillarity and have a certain degree of polarity and a certain degree of non-polarity so that the solvent-substitution solvent may be reused by easily separating and collecting the solvent-substitution solvent from a mixture of the solvent-substitution solvent and water obtained after a solvent substituting and/or hydrophobizing process.

Pentanol has chemical hydrophilicity and hydrophobicity most suitable for substituting moisture contained in fine pores of silica without causing shrinkage of the pores.

Methanol or ethanol, generally considered as a solvent-substitution solvent, may not be suitable for the production of an aerogel even though solvent substitution occurs completely if methanol or ethanol is used. The reason for this is the capillary action of methanol or ethanol causes shrinkage of pores during a drying process. As illustrated in an image of FIG. 2 taken from an aerogel obtained through a solvent substitution process using ethanol and a drying process, small, hard beads are formed due to shrinkage during a water-removing process. In addition, since methanol and ethanol are hydrophilic, methanol or ethanol is not layered and separated from a mixture of methanol or ethanol and water discharged from a wet gel. Therefore, it is difficult to collect and reuse methanol and ethanol.

If propanol is used, the shrinkage of pores may be prevented when a lyogel is dried. However, since propanol is very hydrophilic, propanol may not be layered and separated from a mixture of water and propanol. Therefore, it is difficult to collect and reuse propanol.

When butanol is used as a solvent-substitution solvent, the butanol is used together with a silylating agent to simultaneously perform solvent substitution and hydrophobization, or the butanol is first used for solvent substitution and then a silylating agent is used for hydrophobization. However, in the case of the related-art method of using butanol, if a certain amount of a silylating agent is added, butanol and water may not be layered and separated from each other depending on the kind of the silylating agent, and thus the butanol may not be collected for reuse.

For example, when a butanol solvent and an methoxytrimethylsilane (MTMS) silylating agent are used, a three-component material system including a silica wet gel, butanol, and MTMS is contained in a reactor. In this case, OH groups formed on the surface of the silica wet gel react with the butanol to form butyl groups on the surface of the silica wet gel as illustrated in Reaction Formula 1 below:

Si—OH+OH—C₄H₉→Si—O—C₄H₉+H₂O (1)

In addition, the MTMS is hydrolyzed by a large amount of water contained in the silica wet gel as illustrated by Reaction Formula 2 below:

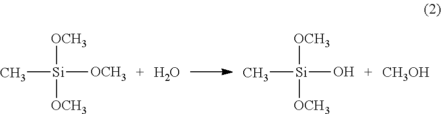

As illustrated in Reaction Formula 2, methanol is produced as a by-product. That is, if a large amount of a silylating agent is added, a large amount of methanol functioning as an intermediate medium between butanol and water is produced, and thus layers of water and butanol disappear. Therefore, it may be difficult to collect a butanol solvent and perform a continuous distillation process. Thus, it may be important to prevent the generation of a large amount of methanol. In addition, since a solution is reused in an aerogel production process, when a silylating agent is added for the second time, the amount of the silylating agent is determined based on the amount of the silylating agent used in the first reaction process and the amount of the silylating agent remaining in the reused solution. However, it is inconvenient to repeatedly measure the amount of the silylating agent remaining in the reused solution, and it is also difficult to measure the amount of the silylating agent existing in a reaction product. Therefore, if an aerogel production process does not require the measurement and/or control of the amount of a silylating agent causing the above-described problems, the aerogel production process may be very effectively performed.

When a lyogel prepared through a solvent substitution process using pentanol is dried, pores of the lyogel are not shrunk by the capillary action of the pentanol, and thus an aerogel having a superior fine porous structure may be obtained from the lyogel. In addition, since pentanol is less hydrophilic than propanol or butanol, pentanol may easily be layered and separated from a mixture of pentanol and water discharged from a wet gel, and thus a pentanol solvent may be efficiently collected at a high degree of purity for the reuse thereof. In addition, since the solubility of pentanol in water is low, a small amount of pentanol may be dissolved in water and lost, and thus the loss rate of pentanol may be low. The term “loss rate” refers to the rate of solvent lost due to dissolution of the solvent in water according to the mutual solubility of the solvent and water. In addition, since pentanol has a high degree of hydrophobicity, an aerogel obtained through a solvent substitution process using pentanol and a drying process has a high degree of hydrophobicity lasting for a long time even though the aerogel is not treated through a surface hydrophobizing process using an additional hydrophobizing agent (such as a silylating agent).

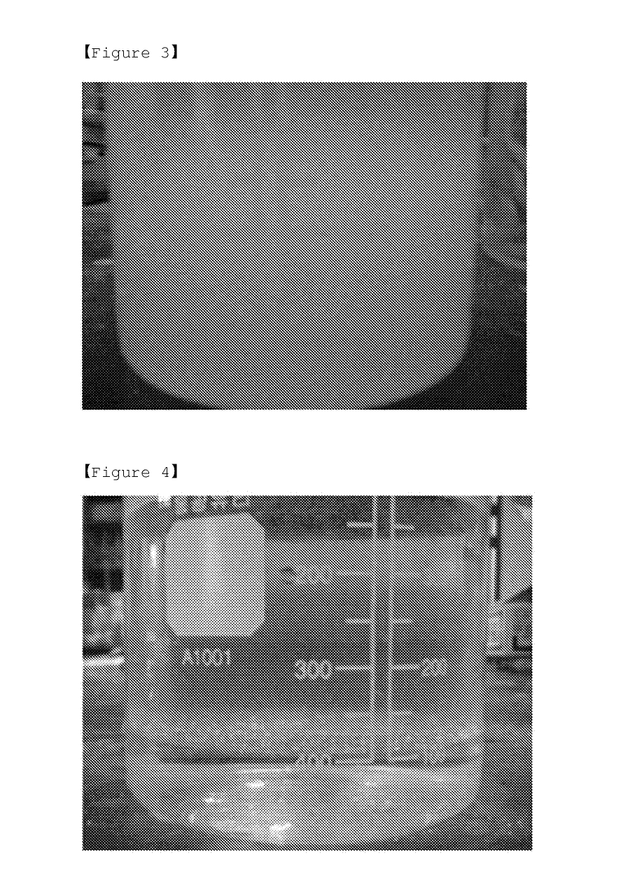

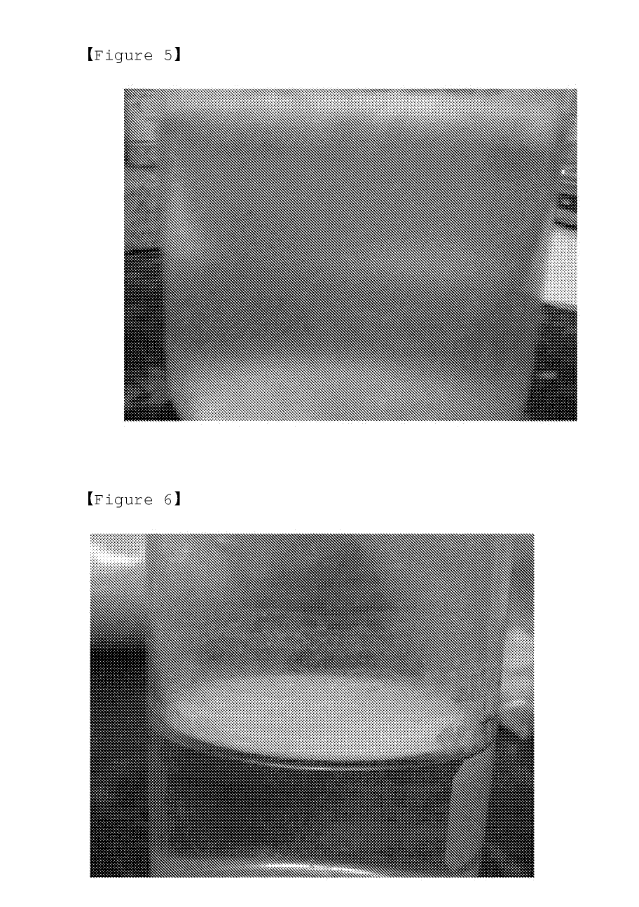

Owing to these reasons, pentanol is suitable as a solvent-substitution solvent in an aerogel production process when compared to butanol. That is, although a large amount of methanol is produced because of the use of an MTMS silylating agent, pentanol and water may be stably layered and separated. FIG. 3 is an image of a mixture solution prepared by mixing 200 ml of butanol and 100 ml of water, and adding 20 ml of methanol thereto after observing a layered state. FIG. 4 is an image of a mixture solution prepared by mixing 200 ml of pentanol and 100 ml of water, and adding 20 ml of methanol thereto after observing a layered state. As illustrated in FIGS. 3 and 4, a layered state disappears in the case of using butanol as in FIG. 3, but a layered state is clearly maintained in the case of using pentanol, as illustrated in FIG. 4. That is, although a large amount of methanol is produced because of the use of a large amount of a particular silylating agent, a layered state of pentanol and water is maintained, and thus it is unnecessary to measure the content of the silylating agent or control the content of the silylating agent within a proper range in the middle of a reaction process.

FIG. 5 is an image of an aerogel inserted into water after the aerogel was obtained through a solvent substitution process using butanol and a drying process, and FIG. 6 is an image of an aerogel inserted into water after the aerogel was obtained through a solvent substitution process using pentanol and a drying process. As illustrated in FIGS. 5 and 6, an aerogel obtained through a solvent substitution process using butanol quickly dissolves in water. However, an aerogel obtained through a solvent substitution process using pentanol floats in water owing to the hydrophobicity thereof, and this state lasts for several months or longer, for example, three months or longer, preferably, 6 months or longer. That is, if the solvent-substitution solvent of the embodiment of the present disclosure is used, the surface of silica may be hydrophobized to some degree owing to pentanol. That is, an aerogel which is hydrophobized on the surface thereof may be obtained without having to perform an additional surface hydrophobizing process using a hydrophobizing agent (such as a silylating agent). In addition, the surface of silica may be fully hydrophobized through a surface hydrophobizing process even though the amount of a hydrophobizing agent such as a silylating agent used in the surface hydrophobizing process is smaller than a common amount.

Since hexanol or heptanol has a too low a degree of hydrophilicity, it is difficult for hexanol or heptanol to reach the surface of a wet gel and react therewith (for example, for substituting for water), and thus pores of the wet gel may shrink in the middle of a reaction. Non-polar substances such as acetone, ether, hexane, and heptane are not suitable because such substances result in shrinkage of pores during a solvent substitution process and/or a drying process. FIG. 7 is an image of an aerogel obtained through a solvent substituting and hydrophobizing process using heptanol and a drying process. Referring to FIG. 7, due to improper removal of water from a wet gel during the solvent substituting and hydrophobizing process, the aerogel was shrunk as compared to the original size thereof, and many cracks were formed in beads. In addition, when the aerogel was touched, it could be found that the aerogel was shrunk and hardened.

In the present disclosure, the term “wet gel” refers to a gel having a fine porous structure filled with water. Furthermore, in the present disclosure, the term “lyogel” refers to a gel having a fine porous structure filled with a liquid (such as a solvent) instead of water. Furthermore, in the present disclosure, the term “aerogel” refers to a gel having a fine porous structure filled with air.

According to embodiments of the present disclosure, solvent-substitution solvents for producing aerogels are provided as follows.

An embodiment of the present disclosure provides a solvent-substitution solvent for producing an aerogel, the solvent-substitution solvent including pentanol in an amount of 41 wt % to 100 wt % and n-butanol in an amount of 0 wt % to 59 wt %. That is, the solvent-substitution solvent includes a pentanol solvent or a solvent mixture of pentanol and n-butanol. The solvent mixture of pentanol and n-butanol may include pentanol in an amount of 41 wt % to less than 100 wt % and n-butanol in an amount of greater than 0 wt % to 59 wt %, for example, pentanol in an amount of 50 wt % to 100 wt % and n-butanol in an amount of 0 wt % to 50 wt %, for example, pentanol in an amount of 55 wt % to 95 wt % and n-butanol in an amount of 5 wt % to 45 wt %, for example, pentanol in an amount of 60 wt % to 95 wt % and n-butanol in an amount of 5 wt % to 40 wt %, for example, pentanol in an amount of 65 wt % to 95 wt % and n-butanol in an amount of 5 wt % to 35 wt %, for example, pentanol in an amount of 55 wt % to 90 wt % and n-butanol in an amount of 10 wt % to 45 wt %, for example, pentanol in an amount of 60 wt % to 90 wt % and n-butanol in an amount of 10 wt % to 40 wt %, for example, pentanol in an amount of 65 wt % to 90 wt % and n-butanol in an amount of 10 wt % to 35 wt %, for example, pentanol in an amount of 55 wt % to 90 wt % and n-butanol in an amount of 10 wt % to 45 wt %.

If the mixture ratio of pentanol and n-butanol is outside of the above-mentioned range, the solvent mixture may be collected at a low rate and low degree of purity, and an aerogel may not be sufficiently hydrophobized though only a solvent substitution process.

Another embodiment of the present disclosure, a solvent-substitution solvent includes at least one alcohol solvent (hereinafter referred as a second solvent component) selected from the group consisting of methanol, ethanol, and propanol, in addition to including a pentanol solvent or a solvent mixture of pentanol and n-butanol (hereinafter referred as a second solvent component).

In the solvent-substitution solvent of the embodiment including a pentanol solvent or a solvent mixture of pentanol and n-butanol (a first solvent component) and an alcohol selected from the group consisting of methanol, ethanol, and propanol (a second solvent component), the amount of the second solvent component may be determined such that the solvent-substitution solvent and water may be layered and separated from a mixture (for example, including water, the solvent-substitution solvent, and an arbitrary hydrophobizing agent) obtained after a solvent substituting and/or hydrophobizing process performed on a wet gel by using the solvent-substitution solvent. For example, in the solvent-substitution solvent further including the second solvent component, the content of the second solvent component may be 40 wt % or less, preferably 30 wt % or less, more preferably 20 wt % or less, much more preferably 10 wt % or less, based on the total weight of the solvent mixture of the first solvent component and the second solvent component. The composition of the solvent-substitution solvent except for the second solvent component is only the first solvent component. Since the solvent-substitution solvent additionally includes the second solvent component, the case of including the second solvent component in an amount of 0 wt % is not considered.

In detail, if the first solvent component is pentanol, for example, the content of the second solvent component in the solvent-substitution solvent may be 40 wt % or less, preferably, 30 wt % or less, more preferably 20 wt % or less, much more preferably 10 wt % or less, based on the total weight of the solvent mixture of the first solvent component and the second solvent component. For example, the solvent-substitution solvent may include pentanol in an amount of 40 wt % or less, preferably 35 wt % or less, more preferably 30 wt % or less, much more preferably 25 wt % or less, still much more preferably 20 wt % or less. For example, the solvent-substitution solvent may include ethanol in an amount of 30 wt % or less, preferably 25 wt % or less, more preferably 20 wt % or less, much more preferably 15 wt % or less. For example, the solvent-substitution solvent may include methanol in an amount of 20 wt % or less, preferably 15 wt % or less, more preferably 10 wt % or less, much more preferably 5 wt % or less.

If the first solvent component is a solvent mixture including pentanol in an amount of 41 wt % to less than 100 wt % and n-butanol in an amount of greater than 0 wt % to 59 wt % (that is, a solvent mixture including pentanol and n-butanol within all the above-mentioned ranges), the solvent-substitution solvent may include the second solvent component in an amount of 40 wt % or less, preferably 35 wt % or less, more preferably 30 wt % or less, more preferably 25 wt % or less, more preferably 20 wt % or less, more preferably 15 wt % or less, more preferably 10 wt % or less, based on the total weight of the solvent mixture of the first solvent component and the second solvent component. For example, if the content of the second solvent component is 30 wt %, the content of the first solvent component is 70 wt %, and the first solvent component may include pentanol and n-butanol at any composition ratio of the embodiment of the present disclosure. For example, the first solvent component may include pentanol in an amount of 41 wt % to less than 100 wt % and n-butanol in an amount of greater than 0 wt % to 59 wt %.

Specifically, for example, when the solvent-substitution solvent includes the second solvent component (for example, propanol) in an amount of 30 wt % and the first solvent component in an amount of 70 wt %, the first solvent component may include 50 wt % pentanol and 50 wt % n-butanol. In this case, for example, 100 g of the solvent-substitution solvent may include 30 g of propanol, 35 g of pentanol, and 35 g of n-butanol.

For example, if the first solvent component is a solvent mixture including pentanol in an amount of 55 wt % to 95 wt % and n-butanol in an amount of 5 wt % to 45 wt % or a solvent mixture including pentanol in an amount of 55 wt % to 90 wt % and n-butanol in an amount of 10 wt % to 45 wt %, the content of the second solvent component may be 35 wt % or less, preferably 30 wt % or less, more preferably 25 wt % or less, more preferably 20 wt % or less, more preferably 15 wt % or less, more preferably 10 wt % or less.

For example, if the first solvent component is a solvent mixture including pentanol in an amount of 60 wt % to 95 wt % and n-butanol in an amount of 5 wt % to 40 wt % or a solvent mixture including pentanol in an amount of 60 wt % to 90 wt % and n-butanol in an amount of 10 wt % to 40 wt %, the content of the second solvent component may be 30 wt % or less, preferably 25 wt % or less, more preferably 20 wt % or less, more preferably 15 wt % or less, more preferably 10 wt % or less.

For example, if the first solvent component is a solvent mixture including pentanol in an amount of 65 wt % to 95 wt % and n-butanol in an amount of 5 wt % to 35 wt % or a solvent mixture including pentanol in an amount of 55 wt % to 90 wt % and n-butanol in an amount of 10 wt % to 45 wt %, the content of the second solvent component may be 25 wt % or less, preferably 20 wt % or less, more preferably 15 wt % or less, more preferably 10 wt % or less.

In the above, the contents of methanol, ethanol, propanol, butanol, and pentanol in the solvent-substitution solvent are mentioned in the case that their concentrations (purity) range from 90 wt % to 95 wt % or higher, and thus if the purity of an alcohol varies, the content of the alcohol in the solvent-substitution solvent may be varied such that the same amount of pure alcohol may be included in the solvent-substitution solvent. In addition, the content of the second solvent component in the solvent-substitution solvent is determined according to the polar and non-polar characteristics thereof because even a small amount of a solvent having a high degree of polarity has a strong effect on the layered separation of the solvent-substitution solvent and water. In the above, exemplary ranges of the content of the first solvent component in the solvent mixture of the first and second solvent components have been described. The exemplary ranges of the content of the first solvent component may be applied to determine the composition of the solvent mixture of the first and second solvent components.

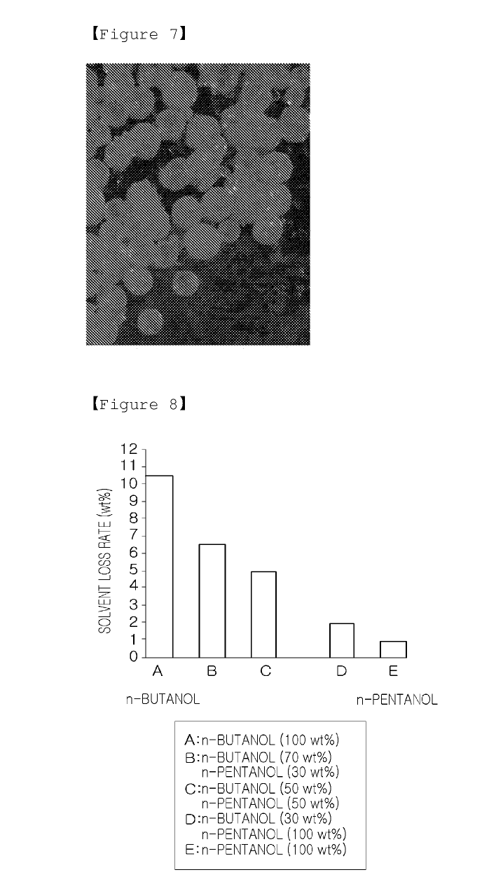

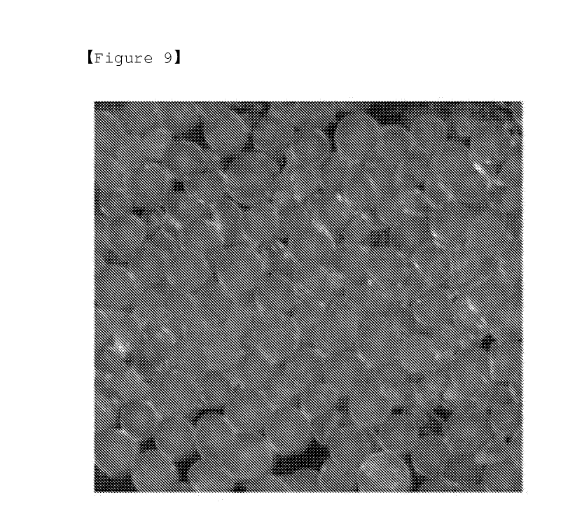

In the related art, for example, an aerogel is produced using a solvent-substitution solvent such as n-butanol or a solvent mixture of n-butanol and n-pentanol in which a large amount of n-butanol is included. In this case, however, the rate of solvent loss is high as illustrated in FIG. 8. FIG. 8 illustrates solvent loss rates respectively measured after equal amounts (weights) of water and a solvent were mixed at room temperature for about 1 hour. The term “loss rate” refers to the rate of solvent lost due to dissolution of the solvent in water according to the mutual solubility of the solvent and water. As illustrated in FIG. 8, as the fraction of n-pentanol increases, the loss rate of a solvent markedly decreases. In detail, when n-pentanol and n-butanol are mixed at a 5:5 ratio, the solvent loss rate is about 5 wt %, and when only n-pentanol is used, the solvent loss rate is about 1 wt %. The solvent loss rate is an important factor in a real process, and even a 1 wt % variation of the solvent loss rate may have a large effect on the price competitiveness of products manufactured in large quantities.

The pentanol may include one or at least two selected from the group consisting of n-pentanol, sec-amyl alcohol (CH₃CH₂CH₂CH(OH)CH₃), 3-pentanol (CH₃CH₂CH(OH)CH₂CH₃), isoamyl alcohol (CH₃(CH₃)CHCH₂CH₂OH), active amyl alcohol (CH₃CH₂CH(CH₃)CH₂OH), sec-isoamyl alcohol ((CH₃)₂CHCH(OH)CH₃), t-butyl carbinol (CH₃(CH₃)₂CCH₂OH), and t-amyl alcohol (CH₃CH₂C(CH₃)₂OH). Particularly, n-pentanol, isoamyl alcohol (CH₃(CH₃)CHCH₂CH₂OH), and t-butyl carbinol (CH₃(CH₃)₂CCH₂OH) may be used.

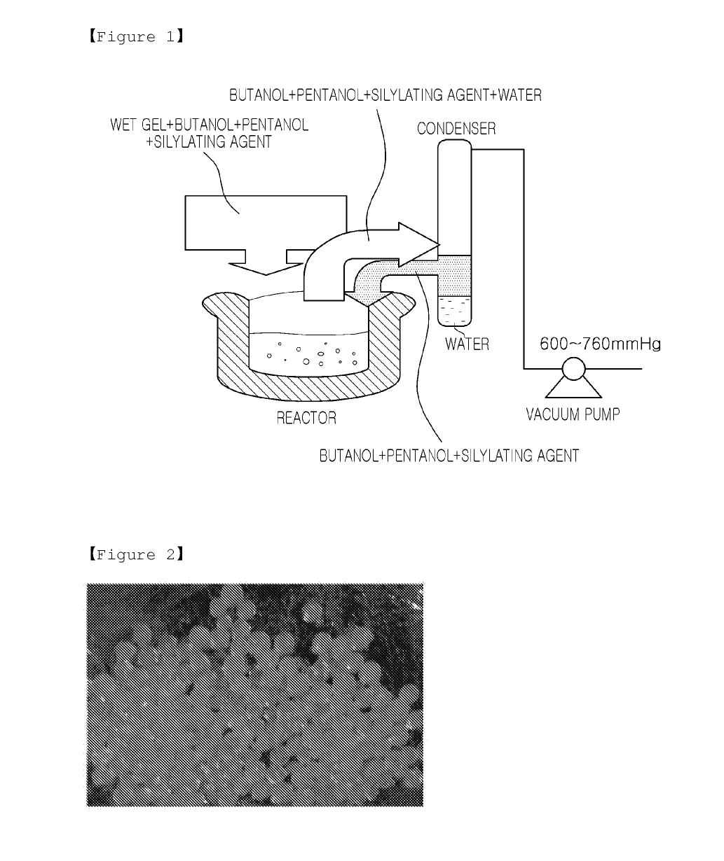

Hereinafter, an explanation will be given of a method for producing a hydrophobized aerogel using the solvent-substitution solvent described in any one of the previous embodiments of the present disclosure. FIG. 1 schematically illustrates a method for producing an aerogel.

An embodiment of the present disclosure provides a method for producing a hydrophobized aerogel, the method including a solvent substitution process in which water (moisture) of a wet gel is substituted with the solvent-substitution solvent described in any one of the previous embodiments of the present disclosure.

In a non-limiting example, the wet gel may be any wet gel known in the related art or manufactured by any method known in the related art.

In the embodiment of the present disclosure, the wet gel may be prepared by adding water glass to hydrochloric acid or sulfuric acid until a pH of 3 to 6 is obtained. The wet gel may be prepared at room temperature (for example, 15° C. to 25° C.). The water glass may be any kind of water glass known in the related art. Non-limiting examples of the water glass include sodium silicate and potassium silicate. One or two kinds of water glass may be used as the water glass. The concentration of hydrochloric acid is not limited. For example, 1 N to 3 N hydrochloric acid may be used in consideration of processability. The concentration of sulfuric acid is not limited. For example, 5 wt % to 50 wt % sulfuric acid may be used in consideration of processability. If water glass is added to hydrochloric acid or sulfuric acid until a solution having a pH of 3 to is obtained, silica included in the solution is polymerized in the form of a gel, and thus a wet gel is obtained. When the wet gel is formed, NaCl and/or KCl produced as a result of side reactions are mixed and remain in the wet gel, and thus the wet gel is washed to remove NaCl and/or KCl.

For example, the wet gel is sufficiently washed with distilled water to remove sodium salts (such as NaCl and/or Na₂SO) and/or potassium salts (such as KCl and/or K₂SO₄). In a non-limiting example, preferably, the wet gel may be washed such that the content of sodium salts and/or potassium salts in the wet gel may be 1 wt % or less. Any washing and filtering methods known in the related art may be used. In a non-limiting example, the wet gel may be washed five or six times with an amount of distilled water that is equal to about ten times the amount of the wet gel. After washing, the moisture content of the wet gel may be, for example, about 80 wt % to about 85 wt %. However, the wet gel is not limited thereto. After washing, the wet gel is filtered to remove distilled water and impurities.

Water (moisture) contained in the wet gel may be substituted with the solvent-substitution solvent described in any one of the previous embodiments of the present disclosure.

Process conditions of the solvent substitution process are not particularly limited as long as the solvent-substitution solvent of any one of the embodiments of the present disclosure is used. That is, the solvent substitution process may be performed by any method known in the related art. For example, the solvent substitution process may be a reflux distillation process or a multi-stage forced contact process. The reflux distillation process and the multi-stage forced contact process are generally known in the related art. In the reflux distillation process, the wet gel and the solvent-substitution solvent are inserted into a reactor and are refluxed while heating the wet gel and the solvent-substitution solvent. In the reflux distillation process, the contents of the wet gel and the solvent-substitution solvent are not particularly limited. Those of ordinary skill in the related art may determine the amounts of the wet gel and the solvent-substitution solvent to be used in the reflux distillation process in consideration of common amounts in the related art. The reflux distillation process may be performed until moisture of the wet gel is substituted with the solvent-substitution solvent. In a non-limiting example, the reflux distillation process may include a single distillation process or a plurality of distillation processes.

In consideration of the efficiency of solvent substitution and processability, the reflux distillation process may be performed at room temperature (for example, 15° C. to 25° C.) or within a temperature range in which the solvent-substitution solvent boils. The boiling point of the solvent-substitution solvent may vary according to the composition of the solvent-substitution solvent, and the boiling points of alcohols are known. Thus, a detailed description thereof will not be given. If the solvent-substitution solvent is a solvent mixture of alcohols, the solvent-substitution solvent may boil at each of the boiling points of the alcohols, and due to this, the composition of the solvent-substitution solvent may be varied at each boiling point.

The solvent substitution process may be performed at positive, atmospheric, or negative pressure. For example, if pressure is adjusted to atmospheric pressure, the solvent substitution process may be efficiently performed at the boiling temperature of the solvent-substitution solvent. For example, if the solvent substitution process is performed at atmospheric pressure, the solvent substitution process may be continued for about 4 hours to about 24 hours to substitute moisture of the wet gel with the solvent-substitution solvent.

If the solvent substitution process is performed at a positive pressure, the positive pressure may be higher than 1 atm but equal to or lower than 10 atm. At a pressure higher than 10 atm, the boiling point of the solvent-substitution solvent is too high, and thus pores of an aerogel may be shrunk. Under the condition of positive pressure, the solvent substitution process may be performed at a process temperature of about 110° C. to about 200° C. If the process temperature is higher than the range, pores may be shrunk in the middle of the solvent substitution process. When the solvent substitution process is performed at a positive pressure, a pressure device equipped with an autoclave or valve may be used. A pressure device equipped with a valve may be useful for controlling pressure using the valve.

If the solvent substitution process is performed in negative pressure, for example, ranging from 30 mmHg to 200 mmHg, solvent substitution may efficiently occur at a relatively low temperature within a relatively short time period when compared to the case in which the solvent substitution process is performed at atmospheric pressure. In detail, since the boiling point of the solvent-substitution solvent is relatively low at negative pressure, solvent substitution may efficiently occur at a temperature of about 40° C. to about 60° C.

If solvent substitution occurs in negative pressure, the temperature of the reactor may be within the range of about 40° C. to about 60° C. because the inside temperature of the reactor is automatically decreased due to rapid evaporation of the solvent-substitution solvent. In this case, heat may be supplied to the reactor from the outside to allow for a rapid reaction. Although solvent substitution rapidly occurs at a low pressure, it may be difficult to reduce the pressure of the reactor to less than 30 mmHg because of loss at a connection line or a vacuum pump connected to the reactor. In addition, when the pressure is decreased to 200 mmHg or lower, the period of time required for solvent substitution may be shortened. Under the condition of negative pressure, the solvent substitution process may be performed for about 40 minutes to about 80 minutes to substitute moisture of the wet gel with the solvent-substitution solvent.

In the reflux distillation process, a boiling portion (evaporated portion) of liquid is directed to a cooling tube or condenser and is cooled. As the evaporated portion is cooled in the cooling tube such as a centrifugal separator or a condenser, moisture (water) discharged from the wet gel is separated into a lower layer, and the solvent-substitution solvent is separated into an upper layer. As described later, if a silylating agent is also used in the solvent substitution process, moisture (water) is separated into an upper layer, and a mixture of the solvent-substitution solvent and the silylating agent is separated into an upper layer.

The water collected in the lower layer may be discharged, and the solvent-substitution solvent (or a mixture of the solvent-substitution solvent and the silylating agent) may be refluxed to the reactor and reused for solvent substitution (or solvent substitution and hydrophobization).

In the forced contact process, water is physically and chemically removed (substituted) by forcibly mixing the wet gel and the solvent-substitution solvent using a mixer. The forced contact process may be performed in multiple stages. That is, although the forced contact process is performed once, all water may not be removed, and thus, the forced contact process may be performed a plurality of times (in multiple stages). Therefore, the forced contact process may require a large amount of the solvent-substitution solvent and may have low efficiency when compared with the reflux distillation process. However, the (multi-stage) forced contact process may be performed on the wet gel as a solvent substitution process. In the forced contact process, the contents of the wet gel and the solvent-substitution solvent are not particularly limited. Those of ordinary skill in the related art may determine the amounts of the wet gel and the solvent-substitution solvent to be used in the forced contact process in consideration of common amounts in the related art. If a silylating agent (described later) is also used in the forced contact process (solvent substitution process), the silylating agent may not be added when the forced contact process is performed for the first time, but may be added when some of the water contained in the wet gel is removed after the forced contact process is performed three or four times, so as to reduce the loss of the silylating agent. However, if the silylating agent is added when most of the water contained in the wet gel is removed after the forced contact process is performed six or seven times, surface hydrophobization may inefficiently occur due to the insufficiency of water for hydrolyzing the silylating agent. In this case, a previously hydrolyzed silylating agent may be used.

In a non-limiting example, the mixing ratio of the wet gel and the solvent-substitution solvent may range from 1:2 to 1:10 in the forced contact process. If the content of the solvent-substitution solvent is lower than the above-mentioned range, it may be difficult for the solvent-substitution solvent to make sufficient contact with pores of the wet gel, and if the content of the solvent-substitution solvent is too excessive, the forced contact process may be inefficiently performed.

In a non-limiting example, the forced contact process may be performed for 1 minute to 60 minutes, preferably 15 minutes to 20 minutes at a time. If the wet gel is forcibly mixed using a piece of equipment such as a mixer, water contained in fine pores of the wet gel is discharged by a negative or positive pressure during strong physical mixing. In addition, water may be dissolved in the solvent-substitution solvent (specifically, a pentanol solvent or a solvent mixture of pentanol and butanol) according to the solubility of water in the solvent-substitution solvent and may be discharged in the dissolved state. This may fully proceed within 5 minutes to 60 minutes. Since the solubility of water in the solvent-substitution solvent is limited, the forced contact process may be repeatedly performed to dissolve more water by newly introducing the solvent-substitution solvent into the wet gel. That is, the forced contact process may be performed two or more times using a proper amount of the solvent-substitution solvent. In a non-limiting example, the forced contact process may be performed about 6 times to about 7 times so as to substitute water of the wet gel with the solvent-substitution solvent. In addition, if the forced contact process is repeatedly performed, moisture (water) contained in the pores of the wet gel may be discharged more effectively by the action of physical mixing. In general, the forced contact process may be performed at room temperature (15° C. to 25° C.) and atmospheric pressure.

The solvent-substitution solvent (or a mixture of the solvent-substitution solvent and the silylating agent) used in the forced contact process may be reused. In a non-limiting example, the solvent-substitution solvent may be reused through a distillation process.

As described above, if the solvent-substitution solvent of any one of the embodiments of the present disclosure is used for solvent substitution, owing to the strong hydrophobicity of pentanol, a hydrophobized aerogel may be obtained without having to use a hydrophobizing agent such as a silylating agent.

According to another embodiment of the present disclosure, if necessary, a hydrophobizing agent such as a silylating agent may be used together with the solvent-substitution solvent in the solvent substitution process so as to simultaneously perform solvent substitution and hydrophobization. In addition, according to another embodiment of the present disclosure, if necessary, after the solvent substitution process, an additional hydrophobizing process may be performed using a hydrophobizing agent such as a silylating agent so as to hydrophobize an aerogel.

The silylating agent used to hydrophobize an aerogel may be any kind of silylating agent generally known in the related art. In a non-limiting example, the silylating agent may include at least one selected from the group consisting of a substance represented by the following chemical formula R¹₄₋ₙ—SiXₙ and a substance represented by the following chemical formula R²Si—O—SiR³, where n is an integer from 1 to 3; R¹ is selected from the group consisting of a C1-C10 alkyl group, a C3-C8 aromatic group, a C3-C8 aromatic alkyl group, a C3-C7 heteroaromatic alkyl group including at least one heteroatom selected from the group consisting of O, N, S, and P, and hydrogen; X is selected from the group consisting of a halogen selected from the group consisting of F, Cl, Br, and I, a C1-C10 alkoxy group, a C3-C8 aromatic alkoxy group, and a C3-C7 heteroaromatic alkoxy group including at least one heteroatom selected from the group consisting of O, N, S, and P; and R² and R³ are independently selected from the group consisting of a halogen selected from the group consisting of F, Cl, Br, and I, a C1-C10 alkyl group, a C3-C8 aromatic group, a C3-C8 aromatic alkyl group, a C3-C7 heteroaromatic alkyl group including at least one heteroatom selected from the group consisting of O, N, S, and P, and hydrogen. For example, the silylating agent may include at least one selected from the group consisting of methoxytrimethylsilane (MTMS), hexamethyldisiloxane (HMDSO), hexamethyldisilane (HMDS), and trimethoxymethylsilane (TMMS). One or at least two of the listed materials may be used as the silylating agent. In general, commercially available silylating agents have purity within the range of 90 wt % or higher, for example, 90 wt % to 99 wt %. One such silylating agent may be used.

In addition, water or an acid may be added to the silylating agent according to need and/or the kind of the silylating agent. If water or an acid is added to the silylating agent, the silylating agent is converted into an intermediate substance having a relatively high degree of reactivity with respect to silica surfaces. Furthermore, the addition of water or an acid may prevent unnecessary consumption of the silylating agent when compared to the case in which water or an acid is not added to the silylating agent. The acid may be an inorganic acid such as hydrochloric acid, sulfuric acid, or nitric acid, or may be acetic acid. One or at least two of the listed acids may be used. For example, unnecessary consumption of the silylating agent may be prevented by adding the acid to the silylating agent until reactants have a pH of 2 to 4.

For example, if water or an acid is not added, the silylating agent may be unnecessarily consumed depending on the kind of the silylating agent. For example, an MTMS silylating agent may be unnecessarily consumed through being hydrolyzed by water contained in a silica wet gel. Therefore, a hydrolysate of the silylating agent may be used to prevent unnecessary consumption of the silylating agent. Water may be added to the silylating agent in an amount corresponding to the equivalent ratio of the silylating agent and water in hydrolysis.

In addition, if an MTMS silylating agent is exposed to air for a long time, the MTMS silylating agent may be polymerized as illustrated by the following Reaction Formula 3. This polymerization may be prevented by adding acetic acid or an inorganic acid such as hydrochloric acid, sulfuric acid, or nitric acid to adjust the pH of reactants to a value ranging from 2 to 4. However, if a new silylating agent not exposed to air for a long period of time is used, an acid may not need to be added.

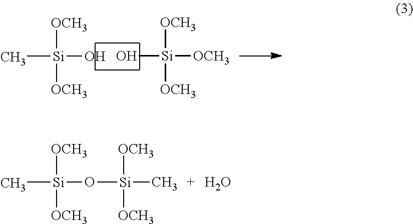

The content of the silylating agent is not particularly limited but may be determined according to a common value in the related art. For example, 1 part by weight to 500 parts by weights of the silylating agent may be used based on 100 parts by weight of a dried aerogel (a final product). In more detail, 1 part by weight to 500 parts by weight of a silylating agent having purity within the range of 90 wt % or higher, preferably within the range of 90 wt % to 99 wt % may be used based on 100 parts by weight of a dried aerogel. The use of a small amount of the silylating agent is favored. In the method of the embodiment of the present disclosure, however, although a certain kind of silylating agent is excessively used, the above-mentioned problems are not caused, and thus when hydrophobizing a wet gel or lyogel, the silylating agent may be used in a wide range of amounts without the amount of the silylating agent having to precisely adjusted to be less than a certain reference value. If the content of the silylating agent is less than 1 part by weight, hydrophobization may be insufficient, and if the content of the silylating agent is greater than 500 parts by weight, it may be uneconomical.

If hydrophobization is simultaneously performed together with solvent substitution in a single process, the same process conditions as those of the solvent substitution process may used. However, if an additional hydrophobizing process is performed after the solvent substitution process, a solvent may be used if necessary. Any solvent generally known as a solvent for hydrophobization in the related art may be used, and the solvent-substitution solvent of any one the embodiments of the present disclosure may be used. Non-limiting examples of the solvent include aliphatic alcohols (such as methanol, ethanol, propanol, butanol, pentanol, and/or hexanol), acetone, tetrahydrofuran, pentane, hexane, heptane, toluene, and water.

The hydrophobizing process may be performed under any process conditions known in the related art without limitation. For example, the hydrophobizing process may be performed under the same process conditions as those of the solvent substitution process according to the method of the embodiment of the present disclosure.

After the solvent substitution process or the (optional) hydrophobizing process, an aerogel is obtained by drying a lyogel. Any drying method or conditions known in the related art may be used. That is, as long as the properties of the aerogel do not deteriorate, any drying method and conditions known in the related art may be used. For example, the lyogel may be dried at room temperature (15° C. to 25° C.) or 250° C. and atmospheric pressure.

In addition, for example, the following drying method may be used, and the solvent-substitution solvent and/or the solvent used in the hydrophobizing process may be collected and reused if necessary. For example, the lyogel may be dried at a pressure of about 30 mmHg to atmospheric pressure (760 mmHg) within the temperature range of room temperature to about 160° C.

If the solvent substitution process and/or the optional hydrophobizing process are performed by a reflux distillation method, a reflux line may be closed after the solvent substitution process and/or the optional hydrophobizing process, and a lyogel in which moisture contained in pores is substituted with the solvent-substitution solvent may be dried to obtain a hydrophobized aerogel. In detail, for example, the solvent-substitution solvent collected in a reflux distillation process may not be supplied back to the reflux distillation process, and reactants may be continuously distilled at atmospheric pressure or negative pressure so as to dry the solvent-substitution solvent contained in the lyogel and thus obtain a hydrophobized aerogel.

As described above, according to the method of the embodiment of the present disclosure, the solvent-substitution solvent may be easily collected and separated at a high degree of purity. Furthermore, it is unnecessary to precisely control the content of a silylating agent according to the kind of the silylating agent. In addition, a hydrophobized aerogel having a large specific surface area and a high degree of porosity and capable of maintaining hydrophobicity for a predetermined period of time may be obtained without having to perform an additional hydrophobizing process. The aerogel obtained by the method of the embodiment of the present disclosure may be provided in the form of powder or beads. Processes for forming the aerogel into powder or beads are commonly known in the related art, and the embodiment of the present disclosure is not limited thereto.

### MODE FOR INVENTION

Embodiments of the present disclosure will now be described more specifically through examples. The following examples are provided to specifically describe the embodiments of the present disclosure and are not intended to limit the scope of the present disclosure.

### Example 1

25 wt % water glass (sodium silicate) was added to 1 L of 2 N hydrochloric acid at room temperature until a pH of 4 was obtained, and as a result of a reaction between the sodium silicate and the hydrochloric acid, wet gel beads were formed. The wet gel beads were washed with distilled water and filtered to remove impurities. 300 g of the wet gel beads was inserted into a reactor, and 300 g of n-pentanol (an industrial product having a purity of 90 wt % to 95 wt %) was mixed with the wet gel beads. Then, the mixture was reacted at atmospheric pressure for 5 hours through a reflux distillation process by heating the reactor using a heating mantle until a liquid boiled, draining layered water through a lower valve while condensing vapor rising from the boiling liquid using a condenser, and directing a reaction liquid mixture (a solvent-substitution solvent) back to the reactor (taking about 40 minutes if pressure is decreased to 30 mmHg). 240 g of water was collected. A lyogel obtained after the reaction was dried at atmospheric pressure and about 150° C. Before the drying, filtering may be performed if necessary. Aerogel beads prepared as described above had a specific surface area of 580 m²/g and thermal conductivity of 19 mW/mK. The aerogel beads are illustrated in FIG. 9. In the above-described reaction, the rate of solvent loss was 1.6 wt %. The aerogel beads were pulverized into powder and added to water. As illustrated in FIG. 6, the powder was hydrophobic, and the hydrophobicity of the powder lasted for at least several months (for example, about 6 months or longer).

### Example 2

25 wt % water glass (sodium silicate) was added to 1 L of 2 N hydrochloric acid at room temperature until a pH of 4 was obtained, and as a result of a reaction between the sodium silicate and the hydrochloric acid, wet gel beads were formed. The wet gel beads were washed with distilled water and filtered to remove impurities. In addition, about 3500 g of n-pentanol (an amount for 7 times of use) was prepared. 300 g of the silica wet gel beads was added to 440 g of the n-pentanol (solvent), and the resulting mixture was inserted into a mixer and agitated at room temperature for about 5 minutes in a condition of about 7500 rpm. Thereafter, the mixture was filtered, and water layered downward in a filtrate was removed. Then, a solvent layered upward in the filtrate was separately stored. A solid-phase silica material remained after the filtering was mixed with 440 g of the n-pentanol solvent and agitated in the mixer at about 7500 rpm for about 15 minutes. Then, the resulting mixture was filtered to obtain a solid-phase silica material. This process was performed seven times in total. An aerogel was obtained by drying a finally filtered solid-phase silica material in a drying machine at atmospheric pressure and about 150° C. The solvent used in the above may be collected and reused through a distillation process. The aerogel had a specific surface area of 620 m²/g and thermal conductivity of 15 mW/mK. The rate of solvent loss was 1.3 wt %.

### Example 3

25 wt % water glass (sodium silicate) was added to 2 L of 1 N hydrochloric acid at room temperature until a pH of 6 was obtained, and as a result of a reaction between the sodium silicate and the hydrochloric acid, beads of a wet gel beads was formed. The beads of the wet gel were washed with distilled water and filtered to remove impurities. 300 g of powder of the wet gel was inserted into a reactor, and 300 g of n-pentanol (an industrial product having a purity of 90 wt % to 95 wt %) was mixed with the powder of the wet gel. Then, the mixture was reacted at atmospheric pressure for 5 hours through a reflux distillation process by heating the reactor using a heating mantle until a liquid boiled, draining layered water through a lower valve while condensing vapor rising from the boiling liquid using a condenser, and directing a reaction liquid mixture (a solvent-substitution solvent) back to the reactor (taking about 40 minutes if pressure is decreased to 30 mmHg). About 240 g of water was collected. In addition, a hydrolysate of MTMS was prepared by adding 20 g of water to 30 g of MTMS (an industrial product having a purity of 90 wt % to 95 wt %). A lyogel obtained by solvent substitution as described above, the hydrolysate of MTMS, and n-butanol were added to the reactor. Then, the reactor was heated until a liquid boiled, and a reaction was induced in the reactor while performing a reflux distillation process at atmospheric pressure for 30 minutes. The lyogel obtained after the reaction was dried at atmospheric pressure and about 150° C. Before the drying, filtering may be performed if necessary. Aerogel powder obtained as described above had a specific surface area of 596 m²/g and thermal conductivity of 18 mW/mK. In the above-described reaction, the rate of solvent loss was 1.2 wt %.

### Example 4

25 wt % water glass (sodium silicate) was added to 2 L of 10 wt % sulfuric acid at room temperature until a pH of 4 was obtained, and as a result of a reaction between the sodium silicate and the sulfuric acid, wet gel beads were formed. The wet gel beads were washed with distilled water and filtered to remove impurities. Thereafter, 300 g of the wet gel beads was inserted into a reactor, and 300 g of n-pentanol (an industrial product having a purity of 90 wt % to 95 wt %) and 40 g of MTMS (an industrial product having a purity of 90 wt % to 95 wt %) were mixed with the wet gel beads. Then, the mixture was reacted at atmospheric pressure for 5 hours through a reflux distillation process by heating the reactor using a heating mantle until a liquid boiled, draining layered water through a lower valve while condensing vapor rising from the boiling liquid using a condenser, and directing a reaction liquid mixture (a mixture of a solvent-substitution solvent and a silylating agent) back to the reactor (taking about 40 minutes if pressure is decreased to 30 mmHg). In the above-mentioned process, 240 g of water was collected. A lyogel obtained as described above by solvent substitution and hydrophobization was dried at atmospheric pressure and about 150° C. Before the drying, filtering may be performed if necessary. Aerogel beads prepared as described above had a specific surface area of 610 m²/g and thermal conductivity of 18 mW/mK. The aerogel beads are illustrated in FIG. 9. In the above-described reaction, the rate of solvent loss was 1.2 wt %.

### Example 5

25 wt % water glass (sodium silicate) was added to 1 L of 2 N hydrochloric acid at room temperature until a pH of 4 was obtained, and as a result of a reaction between the sodium silicate and the hydrochloric acid, wet gel powder was formed. The wet gel powder were washed with distilled water and filtered to remove impurities. Thereafter, 300 g of the wet gel powder was inserted into a reactor, and 300 g of n-pentanol (an industrial product having a purity of 90 wt % to 95 wt %) and 60 g of MTMS (an industrial product having a purity of 90 wt % to 95 wt %) were mixed with the wet gel powder. Then, the mixture was reacted at atmospheric pressure for 5 hours through a reflux distillation process by heating the reactor using a heating mantle until a liquid boiled, draining layered water through a lower valve while condensing vapor rising from the boiling liquid using a condenser, and directing a reaction liquid mixture (a mixture of a solvent-substitution solvent and a silylating agent) back to the reactor (taking about 40 minutes if pressure is decreased to 30 mmHg). 240 g of water was collected. A lyogel obtained as described above was dried at atmospheric pressure and about 150° C. Before the drying, filtering may be performed if necessary. Aerogel powder obtained as described above had a specific surface area of 580 m²/g and thermal conductivity of 19 mW/mK. The hydrophobicity of the aerogel (powder) lasted for at least several months (for example, at least 6 months). In the above-described reaction, the rate of solvent loss was 1.6 wt %.

### Example 6

25 wt % water glass (sodium silicate) was added to 2 L of 15 wt % sulfuric acid at room temperature until a pH of 5 was obtained, and as a result of a reaction between the sodium silicate and the sulfuric acid, wet gel beads were formed. The wet gel beads were washed with distilled water and filtered to remove impurities. 300 g of the wet gel beads was inserted into a reactor. Then, a solvent mixture of 200 g of n-pentanol (an industrial product having a purity of 90 wt % to 95 wt %) and 100 g of sec-amyl alcohol (CH₃CH₂CH₂CH(OH)CH₃) (an industrial product having a purity of 90 wt % to 95 wt %), and 30 g of MTMS (an industrial product having a purity of 90 wt % to 95 wt %) were mixed with the wet gel beads. Then, the mixture was reacted at atmospheric pressure for 5 hours through a reflux distillation process by heating the reactor using a heating mantle until a liquid boiled, draining layered water through a lower valve while condensing vapor rising from the boiling liquid using a condenser, and directing a reaction liquid mixture (a mixture of a solvent-substitution solvent and a silylating agent) back to the reactor (taking about 40 minutes if pressure is decreased to 30 mmHg). 240 g of water was collected. A lyogel obtained after the reaction was dried at atmospheric pressure and about 150° C. Before the drying, filtering may be performed if necessary. Hydrophobized aerogel beads prepared as described above had a specific surface area of 594 m²/g, thermal conductivity of 16 mW/mK, and density of 0.12 g/m³. The hydrophobicity of the aerogel (beads) lasted for at least several months (for example, at least 6 months). In the above-described reaction, the rate of solvent loss was 1.6 wt %.

### Example 7

25 wt % water glass (sodium silicate) was added to 1 L of 2 N hydrochloric acid at room temperature until a pH of 6 was obtained, and as a result of a reaction between the sodium silicate and the hydrochloric acid, powder of a wet gel was formed. Beads of the wet gel were washed with distilled water and filtered to remove impurities. 300 g of the beads of the wet gel was inserted into a reactor. Then, a solvent mixture of 100 g of n-pentanol (an industrial product having a purity of 90 wt % to 95 wt %) and 200 g of t-butyl carbinol (CH₃(CH₃)₂CCH₂OH) (an industrial product having a purity of 90 wt % to 95 wt %), and 40 g of hexamethyldisiloxane (HMDS) were mixed with the beads of the wet gel. Then, the mixture was reacted at atmospheric pressure for 5 hours by heating the reactor using a heating mantle until a liquid boiled, draining layered water through a lower valve while condensing vapor rising from the boiling liquid using a condenser, and directing a reaction liquid mixture (a mixture of a solvent-substitution solvent and a silylating agent) back to the reactor (taking about 40 minutes if pressure is decreased to 30 mmHg). 240 g of water was collected. A lyogel obtained after the reaction was dried at atmospheric pressure and about 150° C. Before the drying, filtering may be performed if necessary. Hydrophobized aerogel powder prepared as described above had a specific surface area of 592 m²/g, thermal conductivity of 16 mW/mK, and density of 0.12 g/m³. The hydrophobicity of the aerogel (powder) lasted for at least several months (for example, at least 6 months). In the above-described reaction, the rate of solvent loss was 1.4 wt %.

### Example 8

25 wt % water glass (sodium silicate) was added to 2 L of 1 N hydrochloric acid at room temperature until a pH of 3 was obtained, and as a result of a reaction between the sodium silicate and the hydrochloric acid, wet gel beads were formed. The wet gel beads were washed with distilled water and filtered to remove impurities. 300 g of the wet gel beads was inserted into a reactor. Then, a solvent mixture of 150 g of isoamyl alcohol (CH₃(CH₃)CHCH₂CH₂OH) (an industrial product having a purity of 90 wt % to 95 wt %) and 150 g of sec-isoamyl alcohol ((CH₃)₂CHCH(OH)CH₃) (an industrial product having a purity of about 95 wt %), and 40 g of trimethoxymethylsilane (MTMS) (an industrial product having a purity of 90 wt % to 95 wt %) were mixed with the wet gel beads. Thereafter, 1 ml of strong hydrochloric acid was added to the mixture. Then, the mixture was reacted at atmospheric pressure for 5 hours by heating the reactor using a heating mantle until a liquid boiled, draining layered water through a lower valve while condensing vapor rising from the boiling liquid using a condenser, and directing a reaction liquid mixture (a mixture of a solvent-substitution solvent and a silylating agent) back to the reactor (taking about 40 minutes if pressure is decreased to 30 mmHg). 240 g of water was collected. A lyogel obtained as described above was dried at atmospheric pressure and about 150° C. to form an aerogel. Before the drying, filtering may be performed if necessary. Beads of an aerogel obtained as described above had a specific surface area of 602 m²/g and thermal conductivity of 15 mW/mK. The hydrophobicity of the aerogel lasted for at least several months (for example, at least 6 months). In the above-described reaction, the rate of solvent loss was 1.7 wt %.

### Example 9

15 wt % potassium silicate solution (K₂OSiO₂.H₂O) was added to 1 L of 1 N hydrochloric acid at room temperature until a pH of 6 was obtained, so as to prepare a silica wet gel. Thereafter, the wet gel was washed a plurality of times with a sufficient amount of water. Then, wet gel beads were obtained by filtering the wet gel and removing water from the wet gel. Thereafter, 200 g of the silica wet gel, 500 g of sec-amyl alcohol (CH₃CH₂CH₂CH(OH)CH₃) (an industrial product having a purity of 90 wt % to 95 wt %), and 30 g of methoxytrimethylsilane (MTMS) (an industrial product having a purity of 90 wt % to 95 wt %) were inserted into a reactor, and the resulting mixture was boiled in the reactor. While condensing vapor rising from a boiling solution using a condenser, if water was layered in the solution, the water was drained through a lower valve, and a reaction liquid mixture (a mixture of a solvent-substitution solvent and a silylating agent) was directed back to the reactor. In this way, the reaction liquid mixture was reacted at atmospheric pressure for 5 hours. Thereafter, a lyogel obtained as described above was dried at atmospheric pressure and about 150° C. to obtain a hydrophobized aerogel. Beads of the aerogel had a specific surface area of 590 m²/g and thermal conductivity of 19 mW/mK. The rate of solvent loss was 1.8 wt %.

### Example 10

25 wt % water glass (sodium silicate) was added to 2 L of 1 N hydrochloric acid at room temperature until a pH of 6 was obtained, and as a result of a reaction between the sodium silicate and the hydrochloric acid, powder of a wet gel was formed. The powder of the wet gel was obtained by washing the wet gel with distilled water and filtering the wet gel to remove impurities. 300 g of the powder of the silica wet gel was inserted into a reactor. Then, 270 g of n-pentanol (an industrial product having a purity of 90 wt % to 95 wt %), 30 g of methanol (an industrial product having a purity of 90 wt % to 95 wt % or higher), and 40 g of HMDSO (an industrial product having a purity of 90 wt % to 95 wt %) were mixed with the powder of the silica wet gel. In addition, 5 g of 35 wt % hydrochloric acid was added to the reactor to facilitate the activation of a silylating agent and a hydrolysis reaction.

Then, the mixture was reacted for 5 hours through a reflux distillation process by heating the reactor using a heating mantle until a liquid boiled, draining layered water through a lower valve while condensing vapor rising from the boiling liquid using a condenser, and directing a reaction liquid mixture (a mixture of a solvent and a silylating agent) back to the reactor. In the above-mentioned process, about 240 g of water was collected. A lyogel obtained after the reaction was dried at atmospheric pressure and about 150° C. to obtain a hydrophobized aerogel. Powder of the aerogel had a specific surface area of 605 m²/g and thermal conductivity of 18 mW/mK. The rate of solvent loss was 1.8 wt %.

### Example 11

25 wt % water glass (sodium silicate) was added to 2 L of 1 N hydrochloric acid at room temperature until a pH of 6 was obtained, and as a result of a reaction between the sodium silicate and the hydrochloric acid, wet gel beads were formed. The wet gel beads were washed with distilled water and filtered to remove impurities. 300 g of the silica wet gel beads was inserted into a reactor. Then, 240 g of sec-amyl alcohol (an industrial product having a purity of 90 wt % to 95 wt %), 60 g of ethanol (an industrial product having a purity of 90 wt % to 95 wt %), and 40 g of MTMS (an industrial product having a purity of 90 wt % to 95 wt %) were mixed with the silica wet gel beads. Then, the mixture was reacted for 5 hours through a reflux distillation process by heating the reactor using a heating mantle until a liquid boiled, draining layered water through a lower valve while condensing vapor rising from the boiling liquid using a condenser, and directing a reaction liquid mixture (a mixture of a solvent and a silylating agent) back to the reactor. In the above-mentioned process, about 240 g of water was collected. A hydrophobized aerogel was obtained by drying a lyogel obtained as described above at atmospheric pressure and about 150° C. Beads of the aerogel had a specific surface area of 600 m²/g and thermal conductivity of 18.8 mW/mK. The rate of solvent loss was 1.5 wt %.

### Example 12

25 wt % water glass (sodium silicate) was added to 2 L of 20 wt % sulfuric acid at room temperature until a pH of 6 was obtained, and as a result of a reaction between the sodium silicate and the sulfuric acid, wet gel beads were formed. The wet gel beads were washed with distilled water and filtered to remove impurities. 300 g of the silica wet gel beads was inserted into a reactor. Then, 210 g of t-amyl alcohol (an industrial product having a purity of 90 wt % to 95 wt %), and 90 g of propanol (an industrial product having a purity of 90 wt % to 95 wt % or higher), and 40 g of HMDSO (an industrial product having a purity of 90 wt % to 95 wt %) were mixed with the silica wet gel beads. Then, the mixture was reacted for 5 hours through a reflux distillation process by heating the reactor using a heating mantle until a liquid boiled, draining layered water through a lower valve while condensing vapor rising from the boiling liquid using a condenser, and directing a reaction liquid mixture (a mixture of a solvent and a silylating agent) back to the reactor. In the above-mentioned process, about 240 g of water was collected. A lyogel obtained after the reaction was dried at atmospheric pressure and about 150° C. to obtain a hydrophobized aerogel. Before the drying, filtering may be performed if necessary. Beads of the aerogel had a specific surface area of 585 m²/g and thermal conductivity of 19 mW/mK. The rate of solvent loss was 1.6 wt %.

### Example 13

25 wt % water glass (sodium silicate) was added to 2 L of 1 N hydrochloric acid at room temperature until a pH of 6 was obtained, and as a result of a reaction between the sodium silicate and the hydrochloric acid, powder of a wet gel was formed. The powder of the wet gel was washed with distilled water and filtered to remove impurities. Thereafter, 300 g of powder of the silica wet gel was inserted into a reactor, and 250 g of n-pentanol (an industrial product having a purity of 90 wt % to 95 wt %) and 50 g of propanol (an industrial product having a purity of 90 wt % to 95 wt % or higher) were mixed with the powder of the silica wet gel. Then, the mixture was reacted for 5 hours through a reflux distillation process by heating the reactor using a heating mantle until a liquid boiled, draining layered water through a lower valve while condensing vapor rising from the boiling liquid using a condenser, and directing a reaction liquid mixture (a solvent-substitution solvent) back to the reactor. In the above-mentioned process, about 240 g of water was collected. A lyogel obtained after the reaction was dried at atmospheric pressure and about 150° C. to obtain a hydrophobized aerogel. Powder of the aerogel had a specific surface area of 600 m²/g and thermal conductivity of 18.0 mW/mK. The rate of solvent loss was 1.6 wt %.

### Example 14

25 wt % water glass (sodium silicate) was added to 2 L of 1 N hydrochloric acid at room temperature until a pH of 3 was obtained, and as a result of a reaction between the sodium silicate and the hydrochloric acid, powder of a wet gel was formed. The powder of the wet gel was washed with distilled water and filtered to remove impurities. Thereafter, 300 g of the powder of the wet gel was inserted into a reactor, and 380 g of n-pentanol (an industrial product having a purity of 90 wt % to 95 wt %) and 20 g of n-butanol (an industrial product having a purity of 90 wt % to 95 wt %) were mixed with the powder of the wet gel. Then, the mixture was reacted at atmospheric pressure for 5 hours by heating the reactor using a heating mantle until a liquid boiled, draining layered water through a lower valve while condensing vapor rising from the boiling liquid using a condenser, and directing a reaction liquid mixture (a solvent-substitution solvent) back to the reactor (taking about 40 minutes if pressure is decreased to 30 mmHg). 240 g of water was collected. A lyogel obtained after the reaction was dried at atmospheric pressure and room temperature to obtain a hydrophobized aerogel. Before the drying, filtering may be performed if necessary. Powder of the aerogel had a specific surface area of 602 m²/g and thermal conductivity of 15 mW/mK. The hydrophobicity of the aerogel lasted for at least several months (for example, at least 6 months). In the above-described reaction, the rate of solvent loss was 1.6 wt %.

### Example 15

25 wt % water glass (sodium silicate) was added to 2 L of 1 N hydrochloric acid at room temperature until a pH of 3 was obtained, and as a result of a reaction between the sodium silicate and the hydrochloric acid, wet gel beads were formed. The wet gel beads were washed with distilled water and filtered to remove impurities. Thereafter, 300 g of the wet gel beads was inserted into a reactor, and 320 g of sec-amyl alcohol (an industrial product having a purity of 90 wt % to 95 wt %) and 80 g of n-butanol (an industrial product having a purity of 90 wt % to 95 wt %) were mixed with the wet gel beads. Then, the mixture was reacted at atmospheric pressure for 5 hours by heating the reactor using a heating mantle until a liquid boiled, draining layered water through a lower valve while condensing vapor rising from the boiling liquid using a condenser, and directing a reaction liquid mixture (a solvent-substitution solvent) back to the reactor (taking about 40 minutes if pressure is decreased to 30 mmHg). 240 g of water was collected. A lyogel obtained after the reaction was dried at atmospheric pressure and room temperature to obtain a hydrophobized aerogel. Beads of the aerogel had a specific surface area of 612 m²/g and thermal conductivity of 16 mW/mK. The hydrophobicity of the aerogel lasted for at least several months (for example, at least 6 months). In the above-described reaction, the rate of solvent loss was 1.7 wt %.

### Example 16

25 wt % water glass (sodium silicate) was added to 2 L of 35 wt % sulfuric acid at room temperature until a pH of 3 was obtained, and as a result of a reaction between the sodium silicate and the sulfuric acid, wet gel beads were formed. The wet gel beads were washed with distilled water and filtered to remove impurities. Thereafter, 300 g of the wet gel beads was inserted into a reactor, and 300 g of t-butyl carbinol (an industrial product having a purity of 90 wt % to 95 wt %) and 100 g of n-butanol (an industrial product having a purity of 90 wt % to 95 wt %) were mixed with the wet gel beads. Then, the mixture was reacted at atmospheric pressure for 5 hours by heating the reactor using a heating mantle until a liquid boiled, draining layered water through a lower valve while condensing vapor rising from the boiling liquid using a condenser, and directing a reaction liquid mixture (a mixture of a solvent-substitution solvent and a silylating agent) back to the reactor (taking about 40 minutes if pressure is decreased to 30 mmHg). 240 g of water was collected. A lyogel obtained after the reaction was dried at atmospheric pressure and 150° C. to obtain a hydrophobized aerogel. Beads of the aerogel had a specific surface area of 610 m²/g and thermal conductivity of 15 mW/mK. The hydrophobicity of the aerogel lasted for at least several months (at least 6 months). In the above-described reaction, the rate of solvent loss was 1.7 wt %.

### Example 17

25 wt % water glass (sodium silicate) was added to 2 L of 1 N hydrochloric acid at room temperature until a pH of 3 was obtained, and as a result of a reaction between the sodium silicate and the hydrochloric acid, wet gel beads were formed. The wet gel beads were washed with distilled water and filtered to remove impurities. Thereafter, 300 g of the wet gel beads was inserted into a reactor, and 260 g of sec-isoamyl alcohol (an industrial product having a purity of 90 wt % to 95 wt %) and 140 g of n-butanol (an industrial product having a purity of 90 wt % to 95 wt %) were mixed with the wet gel beads. Then, the mixture was reacted at atmospheric pressure for 5 hours by heating the reactor using a heating mantle until a liquid boiled, draining layered water through a lower valve while condensing vapor rising from the boiling liquid using a condenser, and directing a reaction liquid mixture (a solvent-substitution solvent) back to the reactor (taking about 40 minutes if pressure is decreased to 30 mmHg). 240 g of water was collected. A lyogel obtained after the reaction was dried at atmospheric pressure and 160° C. to obtain a hydrophobized aerogel. Beads of the aerogel had a specific surface area of 595 m²/g and thermal conductivity of 15 mW/mK. The hydrophobicity of the aerogel lasted for at least several months (for example, at least 6 months). In the above-described reaction, the rate of solvent loss was 2.2 wt %.

### Example 18

25 wt % water glass (sodium silicate) was added to 2 L of 1 N hydrochloric acid at room temperature until a pH of 3 was obtained, and as a result of a reaction between the sodium silicate and the hydrochloric acid, powder of a wet gel was formed. The powder of the wet gel was washed with distilled water and filtered to remove impurities. A mixture solution of 200 g of t-amyl alcohol (an industrial product having a purity of 90 wt % to 95 wt %) and 200 g of n-butanol (an industrial product having a purity of 90 wt % to 95 wt %) was prepared for about 7 times of use (about 3500 ml). After adding 300 g of the powder of the wet gel to 400 g of the mixture solution, the resulting mixture was inserted into a mixer and agitated at room temperature for 15 minutes in a condition of about 7500 rpm. Thereafter, the mixture was filtered, and water layered downward in a filtrate was removed. Then, a solvent layered upward in the filtrate was separately stored. A solid-phase silica material remained after the filtering was mixed with 400 g of the mixture solution and agitated in a mixer for about 15 minutes. Then, the resulting mixture was filtered to obtain a solid-phase silica material. This process was performed seven times in total.

A hydrophobized aerogel was obtained by drying a finally filtered solid-phase silica material in a drying machine at atmospheric pressure and 150° C. The solvent used in the above may be collected and reused through a distillation process. Powder of the aerogel had a specific surface area of 615 m²/g and thermal conductivity of 15 mW/mK. The hydrophobicity of the aerogel lasted for at least several months (at least 6 months).

### Example 19

Water glass (sodium silicate) was added to 2 L of 1 N hydrochloric acid at room temperature until a pH of 4 was obtained, and as a result of a reaction between the sodium silicate and the hydrochloric acid, wet gel beads were formed. The wet gel beads were washed with distilled water and filtered to remove impurities. 300 g of the wet gel beads was inserted into a reactor. Then, 300 g of n-pentanol (an industrial product having a purity of 90 wt % to 95 wt %), 100 g of n-butanol, and 40 g of MTMS (an industrial product having a purity of 90 wt % to 95 wt %) were mixed with the wet gel beads. Then, the mixture was reacted at atmospheric pressure for 5 hours by heating the reactor using a heating mantle until a liquid boiled, draining layered water through a lower valve while condensing vapor rising from the boiling liquid using a condenser, and directing a reaction liquid mixture (a mixture of a solvent-substitution solvent and a silylating agent) back to the reactor (taking about 40 minutes if pressure is decreased to 30 mmHg). 240 g of water was collected. A lyogel obtained after the reaction was dried at atmospheric pressure and room temperature to obtain beads of an aerogel. The aerogel had a specific surface area of 600 m²/g and thermal conductivity of 19 mW/mK. The rate of solvent loss was 3.1 wt %.

### Example 20

25 wt % water glass (sodium silicate) was added to 2 L of 1 N hydrochloric acid at room temperature until a pH of 6 was obtained, and as a result of a reaction between the sodium silicate and the hydrochloric acid, wet gel beads were formed. The wet gel beads were washed with distilled water and filtered to remove impurities. 300 g of the silica wet gel beads was inserted into a reactor. Then, 150 g of sec-isoamyl alcohol (an industrial product having a purity of 90 wt % to 95 wt %), 150 g of n-butanol (an industrial product having a purity of 90 wt % to 95 wt %), and 40 g of HMDSO (an industrial product having a purity of 90 wt % to 95 wt %) were mixed with the silica wet gel beads. Then, the mixture was reacted for 5 hours through a reflux distillation process by heating the reactor using a heating mantle until a liquid boiled, draining layered water through a lower valve while condensing vapor rising from the boiling liquid using a condenser, and directing a reaction liquid mixture (a mixture of a solvent and a silylating agent) back to the reactor. In the above-mentioned process, about 240 g of water was collected. A lyogel obtained after the reaction was dried at 150° C. and atmospheric pressure to obtain a hydrophobized aerogel. Beads of the aerogel had a specific surface area of 600 m²/g and thermal conductivity of 18 mW/mK. The rate of solvent loss was 5.3 wt %.

### Example 21

25 wt % water glass (sodium silicate) was added to 2 L of 20 wt % sulfuric acid at room temperature until a pH of 3 was obtained, and as a result of a reaction between the sodium silicate and the sulfuric acid, wet gel beads were formed. The wet gel beads were washed with distilled water and filtered to remove impurities. Thereafter, 300 g of the wet gel beads was inserted into a reactor, and 260 g of isoamyl alcohol (an industrial product having a purity of 90 wt % to 95 wt %) and 140 g of n-butanol (an industrial product having a purity of 90 wt % to 95 wt %) were mixed with the wet gel beads. Then, the mixture was reacted at atmospheric pressure for 5 hours by heating the reactor using a heating mantle until a liquid boiled, draining layered water through a lower valve while condensing vapor rising from the boiling liquid using a condenser, and directing a reaction liquid mixture (a solvent-substitution solvent) back to the reactor (taking about 40 minutes if pressure is decreased to 30 mmHg). 240 g of water was collected. A lyogel obtained after the reaction was dried at atmospheric pressure and room temperature to obtain a hydrophobized aerogel. Beads of the aerogel had a specific surface area of 602 m²/g and thermal conductivity of 15 mW/mK. The hydrophobicity of the aerogel lasted for at least several months (at least 6 months). In the above-described reaction, the rate of solvent loss was 3.8 wt %.

### Example 22

25 wt % water glass (sodium silicate) was added to 2 L of 1 N hydrochloric acid at room temperature until a pH of 6 was obtained, and as a result of a reaction between the sodium silicate and the hydrochloric acid, wet gel beads were formed. The wet gel beads were washed with distilled water and filtered to remove impurities. 300 g of the wet gel beads was inserted into a reactor. Then, 180 g of n-pentanol (an industrial product having a purity of 90 wt % to 95 wt %), 120 g of n-butanol (an industrial product having a purity of 90 wt % to 95 wt %), and 40 g of MTMS (an industrial product having a purity of 90 wt % to 95 wt %) were mixed with the wet gel beads. Then, the mixture was reacted at atmospheric pressure for 5 hours through a reflux distillation process by heating the reactor using a heating mantle until a liquid boiled, draining layered water through a lower valve while condensing vapor rising from the boiling liquid using a condenser, and directing a reaction liquid mixture (a solvent-substitution solvent) back to the reactor (taking about 40 minutes if pressure is decreased to 30 mmHg). 240 g of water was collected. A lyogel obtained after the reaction was dried at atmospheric pressure and 150° C. to obtain an aerogel. Beads of the aerogel had a specific surface area of 596 m²/g and thermal conductivity of 18 mW/mK. In the above-described reaction, the rate of solvent loss was 4.7 wt %.

### Example 23

25 wt % water glass (sodium silicate) was added to 2 L of 1 N hydrochloric acid at room temperature until a pH of 6 was obtained, and as a result of a reaction between the sodium silicate and the hydrochloric acid, powder of a wet gel was formed. The powder of the wet gel was washed with distilled water and filtered to remove impurities. Thereafter, 300 g of the powder of the wet gel was inserted into a reactor, and 180 g of n-pentanol (an industrial product having a purity of 90 wt % to 95 wt %) and 120 g of n-butanol (an industrial product having a purity of 90 wt % to 95 wt %) were mixed with the powder of the powder of the wet gel. Then, the mixture was reacted at atmospheric pressure for 5 hours through a reflux distillation process by heating the reactor using a heating mantle until a liquid boiled, draining layered water through a lower valve while condensing vapor rising from the boiling liquid using a condenser, and directing a reaction liquid mixture (a solvent-substitution solvent) back to the reactor (taking about 40 minutes if pressure is decreased to 30 mmHg). 240 g of water was collected. In addition, a hydrolysate of MTMS was prepared by adding 20 g of water to 40 g of MTMS (an industrial product having a purity of 90 wt % to 95 wt %). A lyogel obtained through a solvent substitution process as described above and the hydrolysate of MTMS were added to the reactor. Then, the reactor was heated using a heating mantle until a liquid boiled, and a reaction was induced in the reactor while performing a reflux distillation process at atmospheric pressure for 30 minutes. The lyogel obtained after the reaction was dried, or filtered and dried in a drying machine, so as to obtain an aerogel. Powder of the aerogel had a specific surface area of 596 m²/g and thermal conductivity of 18 mW/mK. In the above-described reaction, the rate of solvent loss was 4.6 wt %.

### Example 24

25 wt % water glass (sodium silicate) was added to 2 L of 1 N hydrochloric acid at room temperature until a pH of 6 was obtained, and as a result of a reaction between the sodium silicate and the hydrochloric acid, wet gel beads were formed. The wet gel beads were washed with distilled water and filtered to remove impurities. 300 g of the wet gel beads was inserted into a reactor. Then, 100 g of n-pentanol (an industrial product having a purity of 90 wt % to 95 wt %), 100 g of n-butanol (an industrial product having a purity of 90 wt % to 95 wt %), and 100 g of propanol (an industrial product having a purity of 90 wt % to 95 wt %) were mixed with the wet gel beads. Then, the mixture was reacted at atmospheric pressure for 5 hours through a reflux distillation process by heating the reactor using a heating mantle until a liquid boiled, draining layered water through a lower valve while condensing vapor rising from the boiling liquid using a condenser, and directing a reaction liquid mixture (a solvent-substitution solvent) back to the reactor (taking about 40 minutes if pressure is decreased to 30 mmHg). 240 g of water was collected. In addition, a hydrolysate of MTMS was prepared by adding 20 g of water to 40 g of methoxytrimethylsilane (MTMS) (an industrial product having a purity of about 90 wt % to about 95 wt %). A lyogel obtained through a solvent substitution process as described above and the hydrolysate of MTMS were added to the reactor. Then, the reactor was heated using a heating mantle until a liquid boiled, and a reaction was induced in the reactor while performing a reflux distillation process at atmospheric pressure for 30 minutes. The lyogel obtained after the reaction was dried at atmospheric pressure and room temperature to obtain an aerogel. Beads of the aerogel had a specific surface area of 596 m²/g and thermal conductivity of 18 mW/mK. In the above-described reaction, the rate of solvent loss was 5.7 wt %.

### Example 25

25 wt % water glass (sodium silicate) was added to 2 L of 1 N hydrochloric acid at room temperature until a pH of 6 was obtained, and as a result of a reaction between the sodium silicate and the hydrochloric acid, wet gel beads were formed. The wet gel beads were washed with distilled water and filtered to remove impurities. 300 g of the silica wet gel beads was inserted into a reactor. Then, 200 g of sec-isoamyl alcohol (an industrial product having a purity of 90 wt % to 95 wt %), 100 g of n-butanol (an industrial product having a purity of 90 wt % to 95 wt %), and 100 g of ethanol (an industrial product having a purity of 90 wt % to 95 wt %), and 40 g of HMDSO (an industrial product having a purity of 90 wt % to 95 wt %) were mixed with the silica wet gel beads. Then, the mixture was reacted for 5 hours through a reflux distillation process by heating the reactor using a heating mantle until a liquid boiled, draining layered water through a lower valve while condensing vapor rising from the boiling liquid using a condenser, and directing a reaction liquid mixture (a mixture of a solvent and a silylating agent) back to the reactor. In the above-mentioned process, about 240 g of water was collected. A lyogel obtained after the reaction was dried at atmospheric pressure and 150° C. to obtain a hydrophobized aerogel. Beads of the aerogel had a specific surface area of 610 m²/g and thermal conductivity of 19 mW/mK. The rate of solvent loss was 2.9 wt %.

### Example 26

25 wt % water glass (sodium silicate) was added to 2 L of 1 N hydrochloric acid at room temperature until a pH of 3 was obtained, and as a result of a reaction between the sodium silicate and the hydrochloric acid, wet gel beads were formed. The wet gel beads were washed with distilled water and filtered to remove impurities. 300 g of the wet gel beads were inserted into a reactor. Then, 180 g of t-amyl alcohol (an industrial product having a purity of 90 wt % to 95 wt %), 180 g of n-butanol (an industrial product having a purity of 90 wt % to 95 wt %), and 40 g of methanol (an industrial product having a purity of 90 wt % to 95 wt %) were mixed with the wet gel beads. Then, the mixture was reacted at atmospheric pressure for 5 hours by heating the reactor using a heating mantle until a liquid boiled, draining layered water through a lower valve while condensing vapor rising from the boiling liquid using a condenser, and directing a reaction liquid mixture (a mixture of a solvent-substitution solvent and a silylating agent) back to the reactor (taking about 40 minutes if pressure is decreased to 30 mmHg). 240 g of water was collected. A lyogel obtained after the reaction was dried at atmospheric pressure and room temperature to obtain a hydrophobized aerogel. Beads of the aerogel had a specific surface area of 615 m²/g and thermal conductivity of 15 mW/mK. The hydrophobicity of the aerogel lasted for at least several months (at least 6 months). In the above-described reaction, the rate of solvent loss was 5.4 wt %.

### Comparative Example 1

25 wt % water glass (sodium silicate) was added to 2 L of 1 N hydrochloric acid at room temperature until a pH of 6 was obtained, and as a result of a reaction between the sodium silicate and the hydrochloric acid, wet gel beads were formed. The wet gel beads were washed with distilled water and filtered to remove impurities. Thereafter, 300 g of the silica wet gel beads was inserted into a reactor, and 300 g of n-butanol (an industrial product having a purity of 90 wt % to 95 wt %) and 40 g of MTMS (an industrial product having a purity of 90 wt % to 95 wt %) were mixed with the silica wet gel beads. Then, the mixture was reacted for 5 hours through a reflux distillation process by heating the reactor using a heating mantle until a liquid boiled, draining layered water through a lower valve while condensing vapor rising from the boiling liquid using a condenser, and directing a reaction liquid mixture (a solvent-substitution solvent) back to the reactor (taking about 40 minutes if pressure is decreased to 30 mmHg). About 240 g of water was collected after the reaction. After the reaction, a reaction product was dried, or only a silica material obtained by filtering the reaction product was separately dried in a drying machine, so as to obtain an aerogel. Beads of the aerogel had a specific surface area of 610 m²/g and thermal conductivity of 18 mW/mK. The rate of solvent loss was 12 wt %.

### Comparative Example 2

25 wt % water glass (sodium silicate) was added to 2 L of 1 N hydrochloric acid at room temperature until a pH of 6 was obtained, and as a result of a reaction between the sodium silicate and the hydrochloric acid, wet gel beads were formed. The wet gel beads were washed with distilled water and filtered to remove impurities. 300 g of the silica wet gel beads and 300 g of n-butanol (an industrial product having a purity of 90 wt % to 95 wt %) were inserted into a reactor at room temperature. Then, the mixture was reacted for 5 hours by heating the reactor using a heating mantle until a liquid boiled, draining layered water through a lower valve while condensing vapor rising from the boiling liquid using a condenser, and directing a reaction liquid mixture (a solvent) back to the reactor (taking about 40 minutes if pressure is decreased to 30 mmHg). About 240 g of water was collected after the reaction. A lyogel obtained after the reaction was dried at atmospheric pressure and room temperature to obtain an aerogel. Beads of the aerogel had a specific surface area of 582 m²/g, thermal conductivity of 19 mW/mK, and density of 0.12 g/m³. The rate of solvent loss was 12 wt %. The beads of the aerogel were almost not hydrophobic and settled in water as illustrated in FIG. 5.

### Comparative Example 3

25 wt % water glass (sodium silicate) was added to 2 L of 1 N hydrochloric acid at room temperature until a pH of 6 was obtained, and as a result of a reaction between the sodium silicate and the hydrochloric acid, beads of a wet gel were formed. The beads of the wet gel were washed with distilled water and filtered to remove impurities. 300 g of the beads of the silica wet gel were inserted into a reactor. Then, 250 g of n-butanol (an industrial product having a purity of 90 wt % to 95 wt %), 50 g of n-pentanol (an industrial product having a purity of 90 wt % to 95 wt %), and 60 g of MTMS (an industrial product having a purity of 90 wt % to 95 wt %) were mixed with the beads of the wet gel. Thereafter, the mixture was reacted for 5 hours through a reflux distillation process by heating the reactor using a heating mantle until a liquid boiled and condensing vapor rising from the boiling liquid using a condenser. In the reflux distillation process, however, a solvent and water were not layered due to methanol produced due to the addition of an excessive amount of a silylating agent, and thus water was not separated from the wet gel. After the reaction, the wet gel was dried at room temperature and atmospheric pressure. However, during the drying, the wet gel shrunk. Beads of a silica gel obtained as describe above has a specific surface area of 360 m²/g and density of 0.48 g/m³. It is difficult to consider the silica gel as an aerogel.

### Comparative Example 4

25 wt % water glass (sodium silicate) was added to 1 L of 2 N hydrochloric acid at room temperature until a pH of 5 was obtained, and as a result of a reaction between the sodium silicate and the hydrochloric acid, beads of a wet gel were formed. The beads of the wet gel were washed with distilled water and filtered to remove impurities. 300 g of the silica wet gel, and 400 g of n-butanol (an industrial product having a purity of 90 wt % to 95 wt %), and 40 g of MTMS (an industrial product having a purity of 90 wt % to 95 wt %) were inserted into a reactor at room temperature. Then, the mixture was reacted for 5 hours by heating the reactor using a heating mantle until a liquid boiled, draining layered water through a lower valve while condensing vapor rising from the boiling liquid using a condenser, and directing a reaction liquid mixture (a solvent) back to the reactor (taking about 40 minutes if pressure is decreased to 30 mmHg). A lyogel obtained after the reaction was dried at atmospheric pressure and room temperature to obtain an aerogel. The aerogel had a specific surface area of 594 m²/g and thermal conductivity of 17 mW/mK. The rate of solvent loss was 11 wt %. The aerogel did not have hydrophobicity and mixed with water.

1. A solvent-substitution solvent for producing an aerogel, the solvent-substitution solvent comprising pentanol in an amount of 41 wt % to 100 wt % and n-butanol in an amount of 0 wt % to 59 wt %.

2. The solvent-substitution solvent of claim 1, wherein the solvent-substitution solvent comprises the pentanol in an amount of 41 wt % to less than 100 wt % and the n-butanol in an amount of greater than 0 wt % to 59 wt %.

3. The solvent-substitution solvent of claim 2, wherein the solvent-substitution solvent comprises the pentanol in an amount of 55 wt % to 95 wt % and the n-butanol in an amount of 5 wt % to 45 wt %.

4. The solvent-substitution solvent of claim 1, further comprising at least one alcohol selected from the group consisting of methanol, ethanol, and propanol.

5. The solvent-substitution solvent of claim 1, wherein the pentanol comprises at least one selected from the group consisting of n-pentanol, sec-amyl alcohol (CH₃CH₂CH₂CH(OH)CH₃), 3-pentanol (CH₃CH₂CH(OH)CH₂CH₃), isoamyl alcohol (CH₃(CH₃)CHCH₂CH₂OH), active amyl alcohol (CH₃CH₂CH(CH₃)CH₂OH), sec-isoamyl alcohol ((CH₃)₂CHCH(OH)CH₃), t-butyl carbinol (CH₃(CH₃)₂CCH₂OH), and t-amyl alcohol (CH₃CH₂C(CH₃)₂OH).

6. A method for producing a hydrophobized aerogel, the method comprising substituting a solvent of a wet gel with the solvent-substitution solvent of claim 1.

7. The method of claim 6, wherein the wet gel is prepared by adding water glass to one of hydrochloric acid or sulfuric acid until a pH of 3 to 6 is obtained.

8. The method of claim 6, wherein in the substituting of the solvent of the wet gel, the solvent-substitution solvent is used together with a silylating agent.

9. The method of claim 6, wherein after the substituting of the solvent of the wet gel, the method further comprises hydrophobizing a lyogel by using a silylating agent, the lyogel being obtained through the substituting of the solvent of the wet gel.

10. The method of claim 6, wherein the substituting of the solvent of the wet gel is performed through a reflux distillation process or a forced contact process.

11. The method of claim 8, wherein the silylating agent is selected from the group consisting of a substance represented by the following chemical formula R¹₄₋ₙ—SiXₙ and a substance represented by the following chemical formula R²Si—O—SiR³,
where n is an integer from 1 to 3,
R¹ is selected from the group consisting of a C1-C10 alkyl group, a C3-C8 aromatic group, a C3-C8 aromatic alkyl group, a C3-C7 heteroaromatic alkyl group comprising at least one heteroatom selected from the group consisting of O, N, S, and P, and hydrogen,
X is selected from the group consisting of a halogen selected from the group consisting of F, Cl, Br, and I, a C1-C10 alkoxy group, a C3-C8 aromatic alkoxy group, and a C3-C7 heteroaromatic alkoxy group comprising at least one heteroatom selected from the group consisting of O, N, S, and P, and
R² and R³ are independently selected from the group consisting of a halogen selected from the group consisting of F, Cl, Br, and I, a C1-C10 alkyl group, a C3-C8 aromatic group, a C3-C8 aromatic alkyl group, a C3-C7 heteroaromatic alkyl group comprising at least one heteroatom selected from the group consisting of O, N, S, and P, and hydrogen.

12. The method of claim 9, wherein the silylating agent is selected from the group consisting of a substance represented by the following chemical formula R¹₄₋ₙ—SiXₙ and a substance represented by the following chemical formula R²Si—O—SiR³,
where n is an integer from 1 to 3,
R¹ is selected from the group consisting of a C1-C10 alkyl group, a C3-C8 aromatic group, a C3-C8 aromatic alkyl group, a C3-C7 heteroaromatic alkyl group comprising at least one heteroatom selected from the group consisting of O, N, S, and P, and hydrogen,
X is selected from the group consisting of a halogen selected from the group consisting of F, Cl, Br, and I, a C1-C10 alkoxy group, a C3-C8 aromatic alkoxy group, and a C3-C7 heteroaromatic alkoxy group comprising at least one heteroatom selected from the group consisting of O, N, S, and P, and
R² and R³ are independently selected from the group consisting of a halogen selected from the group consisting of F, Cl, Br, and I, a C1-C10 alkyl group, a C3-C8 aromatic group, a C3-C8 aromatic alkyl group, a C3-C7 heteroaromatic alkyl group comprising at least one heteroatom selected from the group consisting of O, N, S, and P, and hydrogen.

13. The method of claim 8, wherein the silylating agent is used in an amount of 1 part by weight to 500 parts by weight based on 100 parts by weight of the aerogel which is dried.

14. The method of claim 9, wherein the silylating agent is used in an amount of 1 part by weight to 500 parts by weight based on 100 parts by weight of the aerogel which is dried.

15. A method for producing a hydrophobized aerogel, the method comprising substituting a solvent of a wet gel with the solvent-substitution solvent of claim 2.

16. A method for producing a hydrophobized aerogel, the method comprising substituting a solvent of a wet gel with the solvent-substitution solvent of claim 3.

17. A method for producing a hydrophobized aerogel, the method comprising substituting a solvent of a wet gel with the solvent-substitution solvent of claim 4.

18. A method for producing a hydrophobized aerogel, the method comprising substituting a solvent of a wet gel with the solvent-substitution solvent of claim 5.
